(19) United States
(12) Patent Application Publication
(10) Pub. No.: US 2007/0139661 A1
(43) Pub. Date: Jun. 21, 2007

(54) Systems and methods for producing media products

(75) Inventors: J. Alberto Varela, Thornton, CO (US); Jeremy E. Wadsworth, Broomfield, CO (US); David C. Allen, Denver, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Quark, Inc., Denver, CO (US)

(21) Appl. No.: 10/980,416

(22) Filed: Nov. 2, 2004

Related U.S. Application Data
(60) Provisional application No. 60/522,043, filed on Aug. 5, 2004.
(60) Provisional application No. 60/522,047, filed on Aug. 6, 2004.
(60) Provisional application No. 60/522,044, filed on Aug. 5, 2004.
(60) Provisional application No. 60/522,048, filed on Aug. 6, 2004.

(51) Int. Cl. G06F 3/12; G06Q 99/00; G06F 17/00

(52) U.S. Cl. 358/1.1; 705/1; 715/517

(57) ABSTRACT

Systems and methods for producing media products are disclosed herein. As one example, a system for producing a media product that includes a microprocessor is disclosed. Such a system may include a content object set maintained on a computer readable medium accessible to the microprocessor and software executable to receive a job definition; receive a composition zone definition; receive a layout definition; and export a product in accordance with the job definition and the layout definition to a first media and a second media.

### CROSS REFERENCE TO RELATED APPLICATIONS

The present application claims priority to U.S. Provisional Patent Application No. ______ (Attorney Docket No. 56578/310764) entitled, “Systems and Methods for Media Production,” filed Oct. 26, 2004; U.S. Provisional Patent Application No. 60/522,043 entitled “System for Defining Grouping of Document Elements,” filed Jul. 5, 2004; U.S. Provisional Patent Application No. 60/522,047 entitled “Digital Workflow Guide for the Design of Publications,” filed Jul. 5, 2004; U.S. Provisional Patent Application No. 60/522,044 entitled “System for Interactive Layout of Multimedia Presentations,” filed July 5, 2004; and U.S. Provisional Patent Application No. 60/522,048 entitled “System for Variable Database Publishing,” filed Jul. 5, 2004. The entirety of each of the aforementioned provisional applications is incorporated herein by reference for all purposes.

Further, the present application is related to U.S. patent application No. ______ (Attorney Docket No. 56578-308221) entitled “Systems and Methods for Multi-Format Media Production,” filed by Varela et al.; U.S. patent application No. ______ (Attorney Docket No. 56578-308220) entitled “Systems and Methods for Distributing Media Production,” filed by Allen et al.; U.S. patent application No. ______ (Attorney Docket No. 56578-308222) entitled “Systems and Methods for Facilitating Media Production,” filed by Allen et al.; and U.S. patent application No. ______ (Attorney Docket No. 56578-308706) entitled “Systems and Methods for Re-purposing Content Objects for Media Production,” filed by Wadsworth et al. Each of the aforementioned applications is assigned to an entity common hereto, and filed on a date common herewith. The entirety of each of the aforementioned applications is incorporated herein by reference for all purposes.

### BACKGROUND OF THE INVENTION

The present invention relates to systems and methods for producing media products, and in particular to systems and methods for defining and/or controlling the media production process.

Various software tools have been developed to support the desktop publishing market. Such tools have generally approached desktop publishing from the common paradigm of empowering a single entity to perform a variety of tasks in relation to creating a publication. In general, this approach seemed to create efficiencies by rolling a number of activities performed in the publication process into actions performed by a single entity. It has been found, however, that merely providing the tools to perform an activity is not an acceptable proxy for actually developing the skills and experience to create a publication. In part because of this, the promises of desktop publishing have not been fully realized such that the publication process today still retains many of the inefficient features in existence for centuries.

Hence, for at least the aforementioned reasons, there exists a need in the art for advanced systems and methods to address the needs of the publication industry.

### BRIEF SUMMARY OF THE INVENTION

The present invention relates to systems and methods for producing media products, and in particular to systems and methods for defining and/or controlling the media production process.

Various embodiments of the present invention provide systems for producing a media product. Such systems include a microprocessor based controller that is communicably coupled to a computer readable medium. The computer readable medium includes a content object set and an instruction set. The instruction set includes instructions executable by the microprocessor based controller to receive a job definition, a composition zone definition, and a layout definition. The layout definition includes at least one content object from the content object set. The instructions are further executable to export a product in accordance with the job definition and the layout definition to two or more media.

In one particular case, one of the media is a print media and another of the media is an electronic media. A print media can be, for example, a magazine, a newspaper, a product package, a paper advertisement, a business card, and a painted billboard. An electronic media may be, but is not limited to, a non-interactive Internet page, an interactive Internet page, an electronic billboard; a video program, and an audio program. Other media may include, but are not limited to, a product media such as, for example, a wearable product, a compact disk, a semiconductor device, and a pharmaceutical product.

In some cases, the job definition identifies a set of resources for use in creating the product. Such resources can be, for example, physical resources, electronic media resources, layout resources, and/or brand resources. The physical resources may include, but are not limited to, a paper, a set of inks, a set of fonts, and an image resolution. The electronic media resources may include, but are not limited to, an execution tool, and a frame rate. The execution tool may be, for example, a reader or a plug-in module. The layout resources may include, but are not limited to, pagination, paper folds, image resolution, a tear-out location, and an amount of advertising. The brand resources may include, but are not limited to, one or more content objects included with the content object set.

In various cases, the composition zone definition includes at least one of a size of a composition zone, a location of the composition zone, and a geometry of the composition zone. In particular instances, the composition zone definition includes a geometry of the composition zone for one media, and another geometry of the composition zone for another media. In some cases, the composition zone definition further includes a context of the composition zone. This context may be, but is not limited to, an abstract of an article located near the composition zone, and a visual mockup of an area surrounding the composition zone. In one particular instance, the composition zone is an advertisement area that includes a purchase cost of the advertisement area and/or a target group of advertisers.

In one or more instances, the layout definition further defines a layout space that is at least in part controlled by the composition zone definition. The layout definition may include, but is not limited to, a size of the layout space. Further, in some cases, the layout space may be controlled at least in part by the job definition.

In one particular instance, the composition zone definition defines a composition zone, and two or more layout definitions are received. Each of the layout definitions are associated with respective portions of the composition zone such that one of the layout definitions includes one content object to be included in one portion of the composition zone, and the other layout definition includes another content object to be included in the other portion of the composition zone.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a computer system useful in relation to various embodiments of the present invention;

FIG. 2 is a flow diagram illustrating a method for distributing media production in accordance with one or more embodiments of the present invention;

FIG. 3 is a graphical representation of exemplary entities involved in forming a job jacket definition in accordance with various embodiments of the invention;

FIG. 4 is a flow diagram illustrating a method for governing media product development in accordance with one or more embodiments of the present invention;

FIG. 5 is a flow diagram illustrating a method for utilizing composition zones in accordance with some embodiments of the present invention;

FIG. 6 provide a graphical portrayal of exemplary uses of composition zones in accordance with various embodiments of the present invention;

FIG. 7 is a flow diagram illustrating a method for re-purposing content objects in accordance with various embodiments of the present invention;

FIG. 8 is a graphical depiction illustrating an exemplary use of a dynamic content object;

FIG. 9 is a flow diagram illustrating a method for storing and maintaining extensible and semi-extensible content objects in accordance with some embodiments of the present invention;

FIG. 10 is a graphic portrayal of an exemplary re-purposing of content objects in accordance with one or more embodiments of the present invention;

FIG. 11 depicts an exemplary synchronization of content objects across various media in accordance with some embodiments of the present invention; and

FIG. 12 depicts an exemplary synchronization of content objects and composition zones across various media in accordance with one or more embodiments of the present invention.

### DETAILED DESCRIPTION OF THE INVENTION

The present invention relates to systems and methods for producing media products, and in particular to systems and methods for defining and/or controlling the media production process.

For purposes of this document, the term “media cell” is any portion of a media production. Thus, as just one example, a media cell can encompass one or more pages of a printed publication, or a portion of a page of the printed production. As another example, a media cell can be a portion of a website, a portion of a product package, or a portion of a video or audio production. In some cases, a media cell can reflect the trim size and placement of a proposed and/or available composition. Based on the disclosure provided herein, one of ordinary skill in the art will recognize a myriad of production media, and media cells that can be associated therewith.

Also for the purposes of this document, the term “composition zone” is any layout area. In some cases, such composition zones are associated with a corresponding media cell, while in other cases a composition zone is independent of a media cell. In yet other cases, the composition zone performs the functions of both the media cell and the layout area. Composition zones can be used to contain one or more content objects that make up a layout such as an advertisement in a magazine or newspaper. Based on the disclosure provided herein, one of ordinary skill in the art will recognize a number of composition zones and purposes thereof that can be utilized in accordance with embodiments of the present invention.

Development of a media product involves a number of entities each applying their particular skill in concert to create the end media product. For example, to develop a printed publication a number of entities can be involved including graphic artists, production artists, pre-press specialists, presses, authors, editors, attorneys, accountants, suppliers, service providers, clients, advertisers, and/or the like. In some cases, each of the entities involved in the development are employed by one company, however, in many cases a number of the entities are third parties. For example, in many cases the presses and pre-press specialists are third parties that impose their own rules and requirements. Further, not only are a number of entities involved in developing a successful end media product, many of the entities have adverse interests and end goals. This increases the complexity producing an effective product.

Various embodiments of the present invention provide systems and methods that facilitate a media production workflow capable of assuring that the input of each of the affected entities is properly considered without undermining the ability of other entities to perform its necessary tasks. For example, some embodiments of the present invention provide software systems for producing a media product. The software includes instructions executable by a microprocessor based controller to receive a job jacket definition; receive a composition zone definition; and to receive a layout definition. Each of these definitions can be impacted by different entities in the production process.

As just one example, the layout definition can be primarily provided by a graphic artist. A graphic artist is typically a highly skilled designer whose primary objective is to create compositions for publications that convey a message for their client. Appropriate treatment of text, color, photography and illustrations are key to successful design. This craft is not for everybody, and for this reason there are relatively few good graphic artists in comparison to all other types of positions held in the publishing industry. Skilled graphic artists find ways to convey their client's messages and drive sales of goods and services that generate revenue that pay for the advertisement several times over. In some cases, a graphic artist is impeded by undue consideration of other aspects related to the publication process. Hence, while the early days of desktop publishing offered a hope of a one stop publication preparation, the hope was often fleeting because a graphic artist was forced to consider aspects not germane to his expertise. Indeed, contrary to the paradigm adopted in the early days of desktop publishing, when good graphic artists are found, the firms that employ them seldom allow them to do anything else other than just design.

A graphic artist typically begins by interviewing their client to determine exactly what message the client is trying to convey, who is the audience, what their tastes are, what their budget is like, time line, and the like. Then, the graphic artist creates a variety compositions from which their client can choose. This may take several iterations and combinations of design ideas before the final design is agreed upon. These designs are often created with limited knowledge of the actual content objects that populate the design. In effect, the designer creates a theme or template into which the content objects are placed. The content itself will often originate from other sources and be merged with the design sometime during the production process.

In the example, the composition zone definition can be primarily provided by a production artist and a pre-press specialist. These specialists have very different skill sets than the previously described graphic artist. For example, while a production artist shares a common vocabulary and some sensitivity to composition with a graphic artist, production artists are typically far less involved with the creative process and more involved with taking a design and preparing it for pre-press. The tasks of production artists might include such things as typesetting, scanning images, digital content creation, ink specification and page layout. Production artists often have a more comprehensive understanding of the press requirements than do graphic artists.

The pre-press specialists are even less sensitive to graphic composition, but provide an even greater understanding of press requirements. The work of pre-press specialists includes, for example, trapping, imposition, proofing, color management, image setting and plate creation. All of these tasks require highly skilled specialists, preferably with several years of experience. Mistakes that are made during the pre-press production cycle can be catastrophic and result extensive money loss during press production. Currently pre-press specialists are typically employed by presses. This allows a pre-press specialist to become highly skilled in the printing processes offered by the press, and assure a high quality production. Some embodiments of the present invention provide definitional tools sufficient to allow a pre-press specialist to operate effectively as an independent contractor with ability to specify for many presses, or within an entity employing graphical and production artists.

Continuing with the example, job jacket definition can be affected by a number of entities including the press. As such, the press can provide rules and limitations directed at assuring that a proposed media production can be reduced to the desired end media product. Other people are also involved in this job jacket definition. For example, accountants and other financial planners can work with suppliers to choose paper and inks that not only work properly with the press, but also provide a cost effective end media product. Further, a production manager can work with suppliers and/or service providers to define materials that will achieve the desired look and feel of the end media product. As another example, attorneys may designate content objects that are to be used to assure a consistent brand recognition, and to assure that content objects with proper disclaimers are included. Also, a production manager, accountant and potential advertisers can work together to define an amount of content verses advertisement that is to be included in the end media product, and also to determine the cost and target market for the advertisements.

In some embodiments of the present invention, the job jacket definition is created first followed in order by the composition zone definition and the layout definition. Each of the definitions is constrained by a preceding definition. For example, the job jacket definition may indicate the total number of pages of a proposed publication as well as a percentage of advertisement. The total number of pages including advertising percentage can be disaggregated into a number of composition zones each serving a discrete purpose to the overall publication. In turn, a layout definition can be provided in accordance with a particular composition zone definition. In the end, all of the definitions can be aggregated to create the final media production. In a sense, some embodiments of the present invention turn the development process on its head by considering first the overall concept, and subsequently forming the individual components of the overall concept. By first considering the overall concept, there is some assurance that a thoughtfully designed media production will be compatible with the media and production processes which will be used to give life to the concept. Further, some embodiments of the present invention provide a mechanism for distributing operations ongoing in relation to developing a media product. At least in part because of this distribution, for example, multiple functions such as the preparation of individual layouts may be performed in parallel while informing entities of development ongoing in other areas through synchronizing the various individual processes into a cohesive whole.

One of ordinary skill in the art will recognize that the foregoing example is just that—one example of many possible examples. Based on the disclosure provided herein, one of ordinary skill in the art will recognize various other entities that can be involved in forming the layout definition, composition zone definition, and job jacket definition. For example, it is conceivable that the distribution of work may be different where a proposed media publication is a professional publication (i.e., newspapers and magazines) verses a corporate publication (i.e., advertisements of goods such as fliers and brochures).

Further embodiments of the present invention provide systems and methods capable of re-purposing media productions across multiple mediums. One or more embodiments of the present invention support a media production process that is, in a sense, an extremely flexible manufacturing process including design, production, pre-press, press and delivery. This manufacturing process can be developed to export the end media product in one or more of many possible formats. For example, a media production or some portion thereof can be purposed for both print and electronic media. This “re-purposing” allows for the costly process of developing a media product to be spread across multiple end media products purposed for respective mediums. Further, this allows for strong brand development where consistent themes, language, and visuals are enforced across mediums.

Such embodiments can employ a content object set that includes a number of content objects reduced to an extensible or semi-extensible maintenance form. As used herein, an extensible maintenance form is one that can be exported or re-purposed for any medium within a defined set of media. In contrast, a semi-extensible maintenance form is a form that is extensible to one or more mediums within the defined set of media, but not to all of the defined set of media. Use of extensible and semi-extensible maintenance forms allows a graphic artist to design within one space (whether media specific or media independent), and to re-purpose a creation to one or more output media. Thus, a graphic artist can treat language as simply text and images as simply pictures. Leaving various styling and formatting for later decision when the end format is decided. Further, this allows multiple designs to be updated through modification of underlying content objects whether in the content object set, or in one or more end media products to which a design was exported.

As used herein, the term “re-purposing” is used in its broadest possible sense to mean any modification of a design, composition zone, layout, content object or other from one format to another. This can include modification from a media independent format to a media specific format and/or from one media specific format to another media specific format. In some cases, re-purposing of content objects can rely on two factors: 1) the content object enjoys some degree of extensibility or is associated with one or more corresponding content objects tailored for different media; and 2) the re-purposing transformations can be applied to the content objects in a target layout. Content objects and layouts that can be re-purposed become highly valuable assets as they allow for relatively inexpensive media product development.

In some cases, a content object or layout that is re-purposed for a specific medium will be modified in order to accommodate or more filly exploit the selected medium. When content is prepared for a specific medium type, specialized tools and methods may be used to ensure an optimum presentation of the content for that medium type. For example, in the context of the print medium type, color attributes can be applied to content that can be separated into the appropriate inks for press reproduction and those inks can trap among elements that intersect. Publications of the web medium type do not have to consider inks and trapping, but in contrast can be able to apply hyperlink attributes to text content and be able to export to Hyper Text Markup Language (“HTML”). For reasons such as these, specialized tools and processes may be used to optimize attributes of the content for a specific purpose.

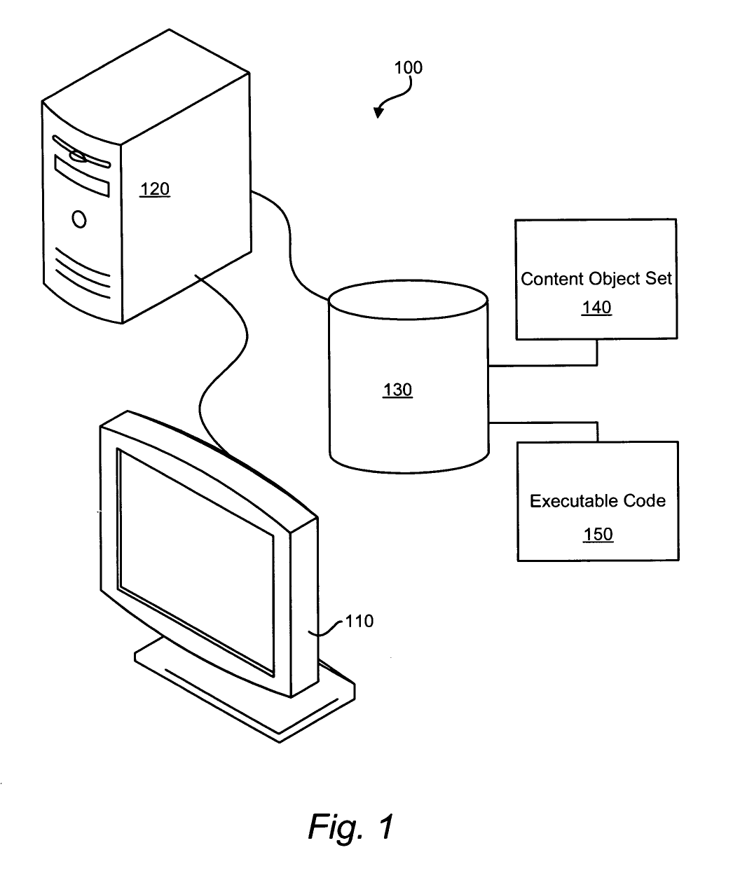

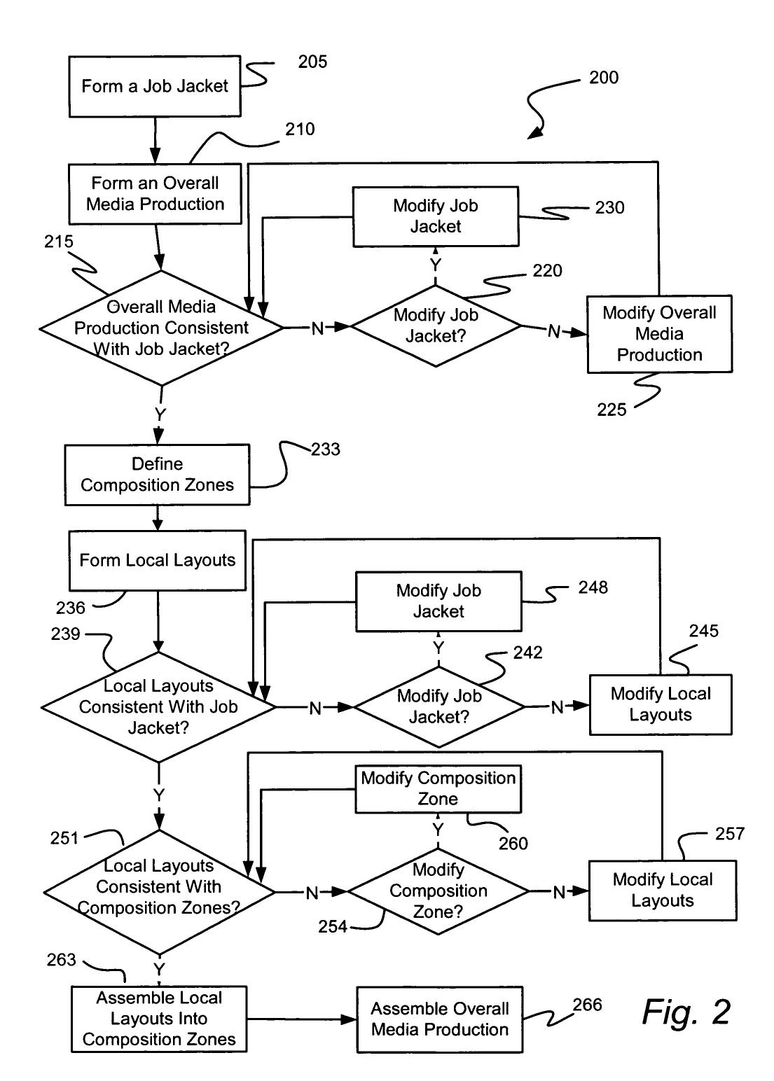

Turning to FIG. 1, a computer system 100 useful in relation to various embodiments of the present invention is illustrated, Computer system 100 includes a microprocessor based controller 120 communicably coupled to a display 110 and a computer readable medium 130. Microprocessor based controller 120 can be any device or system capable of receiving and executing instructions. In one particular case, microprocessor based controller 120 is a personal computer, however, based on the disclosure provided herein, one of ordinary skill in the art will recognize a myriad of devices and systems that can perform the functions of microprocessor based controller 120. Computer readable medium 130 can be any medium accessible to a microprocessor on which data can be maintained. Thus, as just some of many examples, computer readable medium may be a hard disk drive, a floppy diskette, a CD ROM, a USB Memory Stick, a RAM, or any combination thereof. Further, as used herein, the term “communicably coupled” is used in its broadest sense to mean means whereby one device or location is able to send or receive information to/from another, whether directly or indirectly. Thus, components of computer system 100 can be communicably coupled by, among other things, a physical cable, a wireless link, and/or one or more communication networks including the Internet, a WAN, a virtual private network, and/or the like.

Computer readable medium 130 may maintain a content object set 140 and executable software 150. As set forth in more detail below, executable software 150 can comprise instructions executable to cause microprocessor based controller 120 to operate in accordance with one or more of the included flow diagrams. Content object set 140 can include a number of reusable and/or re-purposable content objects. As used herein, the term “content object” is used in its broadest sense to mean any content that can be used in a media production. Thus, for example, a content object can be text, graphics, images, audio, a layout, a composition zone, and/or the like. Further, in some cases, a content object is a “static content object” which is a content object that exists in a static state. Alternatively, a content object can be a “dynamic” content object which is a content object that is populated dynamically based on a rule set. As just two examples, a textual news report is a static content object, while a stock ticker operable to receive and display live market information is a dynamic content object.

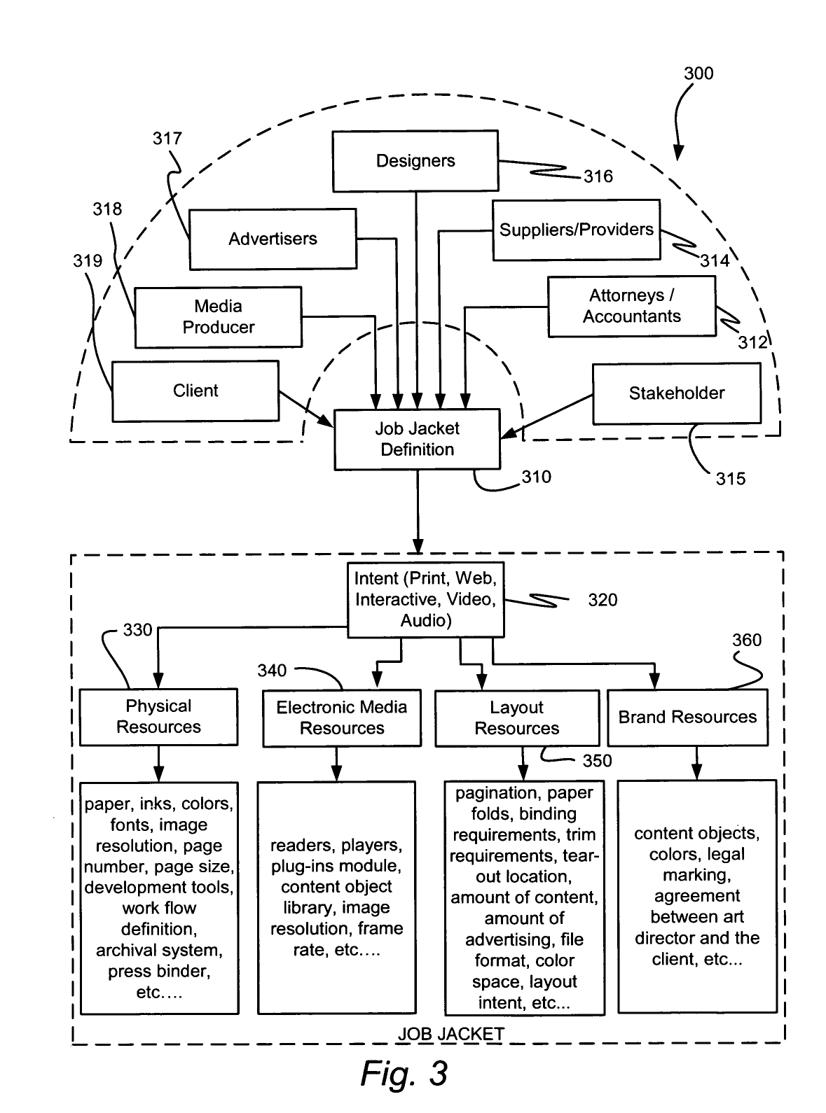

Turning to FIG. 2, a flow diagram 200 illustrates a method for distributing media production in accordance with various embodiments of the present invention. In particular, flow diagram 200 illustrates one exemplary process whereby job jackets, compositions, and layout spaces are utilized in concert to form a media production. Following flow diagram 200, a job jacket is formed (block 205). Such a job jacket can be formed by bringing a number of stakeholders in a given media production together to define the media production. This job jacket can define a number of resources and/or rules to be adhered to during development of the media production. Further discussion of such a job jacket is provided below in relation to FIG. 3.

Based in part on this job jacket, an overall media production is defined by, for example, a layout artist (block 210). Thus, for example, where the media production is a ten page magazine, a layout artist-can define areas for graphics, for text articles, and for advertisements. The overall media production is compared against the job jacket to determine if the two are consistent (block 215). This can include, as just one of many examples, determining whether the amount of advertisements verses content is as prescribed by the job jacket. Where the overall media production is inconsistent with that called for by the job jacket (block 215), it is determined if the job jacket can be modified to allow the overall media-production (block 220). Where the job jacket is to be modified (block 220), it is modified (block 230) and a determination is made of whether the overall media production is consistent with the modified job jacket (block 215). Alternatively, where the job jacket is not to be modified (block 220), the overall media production is modified (block 225) and the modified overall media production is again compared against the job jacket to assure compliance (block 215). Based on the disclosure provided herein, one of ordinary skill in the art will appreciate a myriad of other overall media production modifications that can be made, and/or a variety of job jacket modifications that can be made to facilitate a design in accordance with embodiments of the present invention.

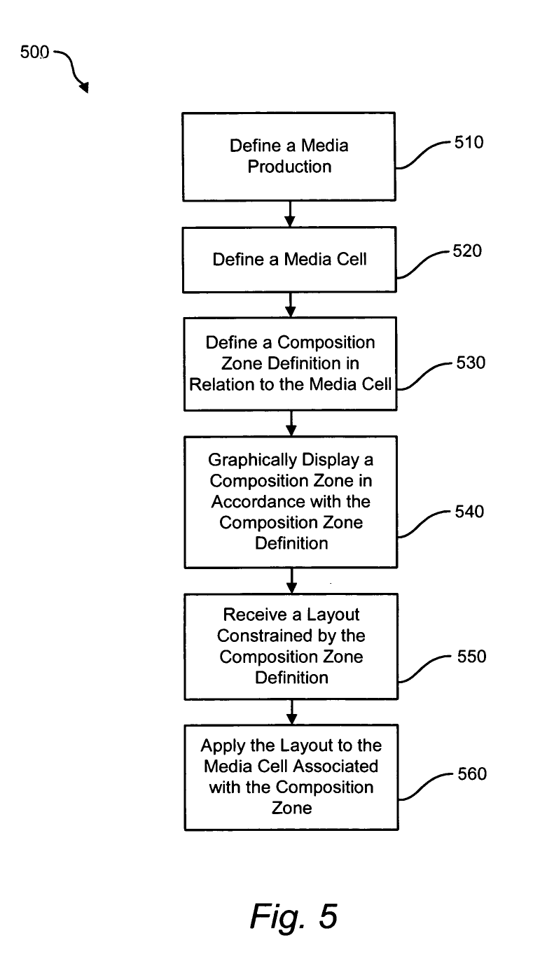

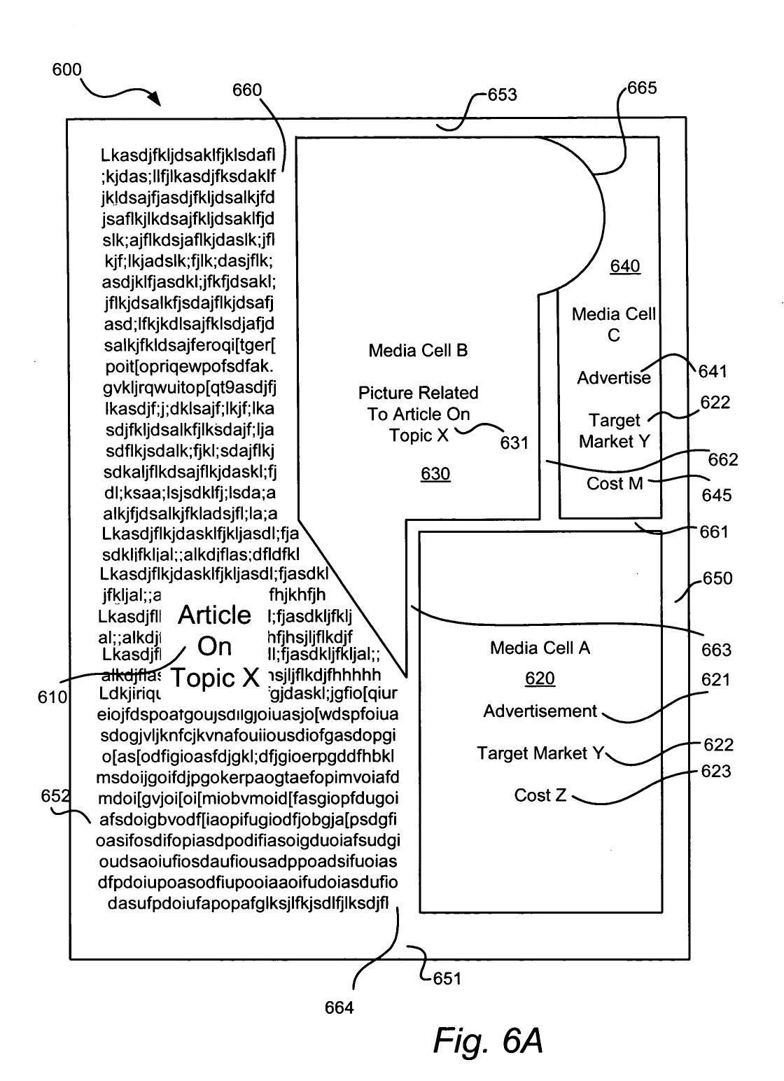

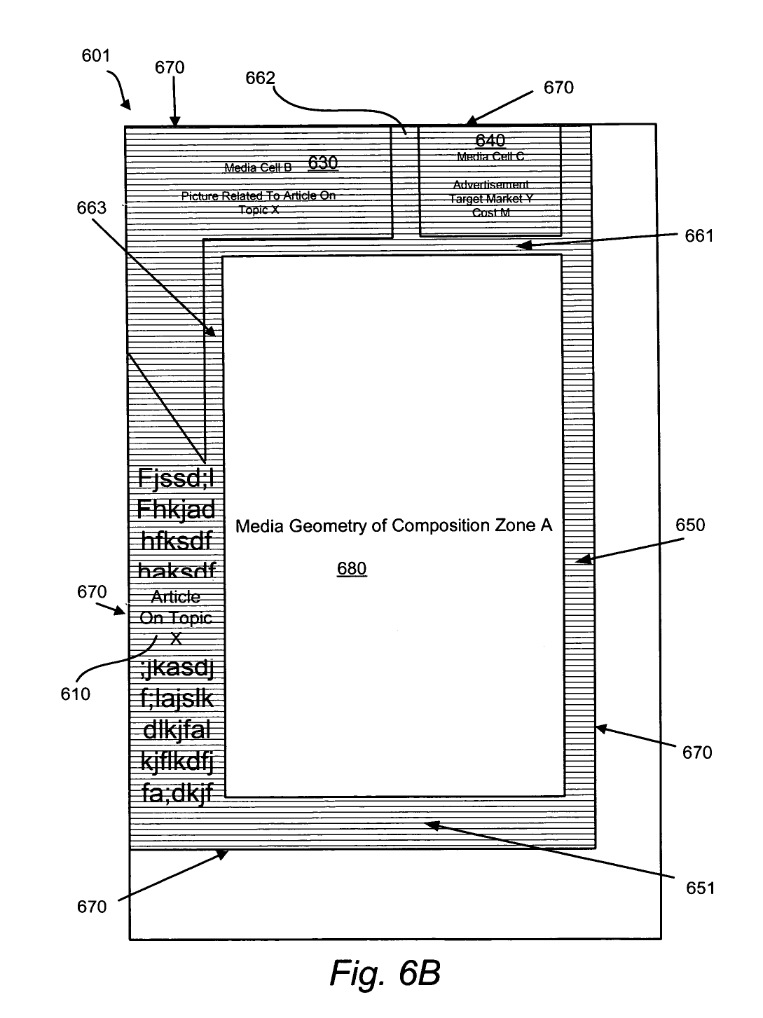

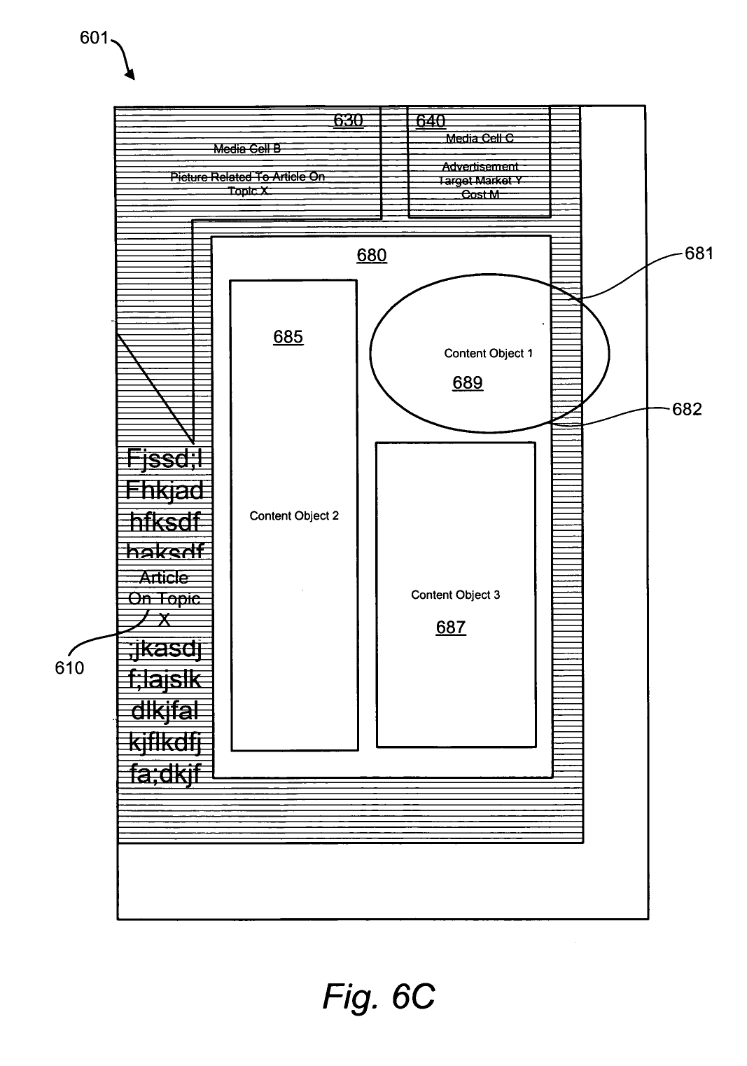

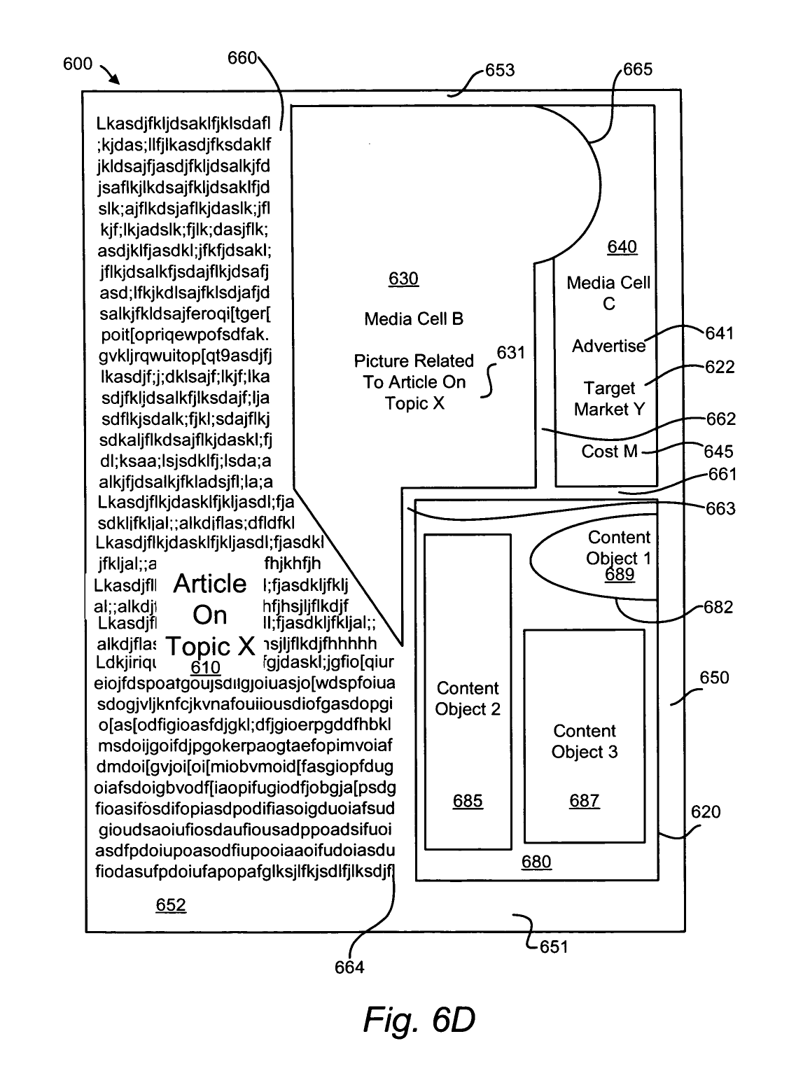

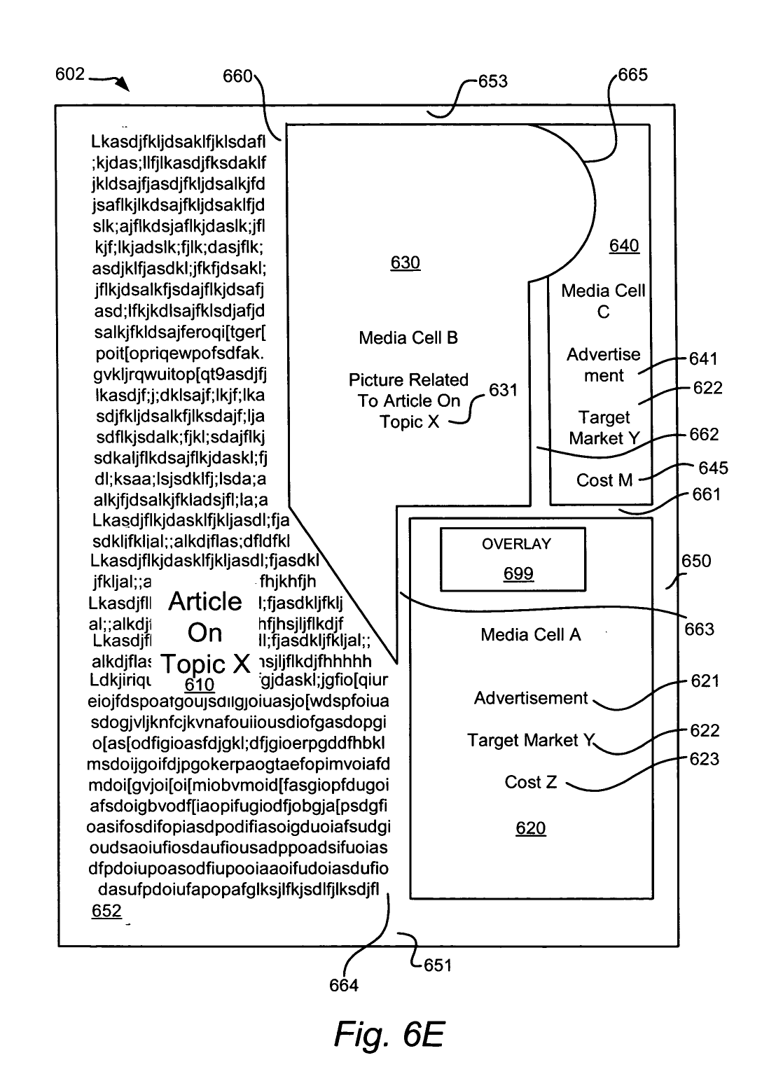

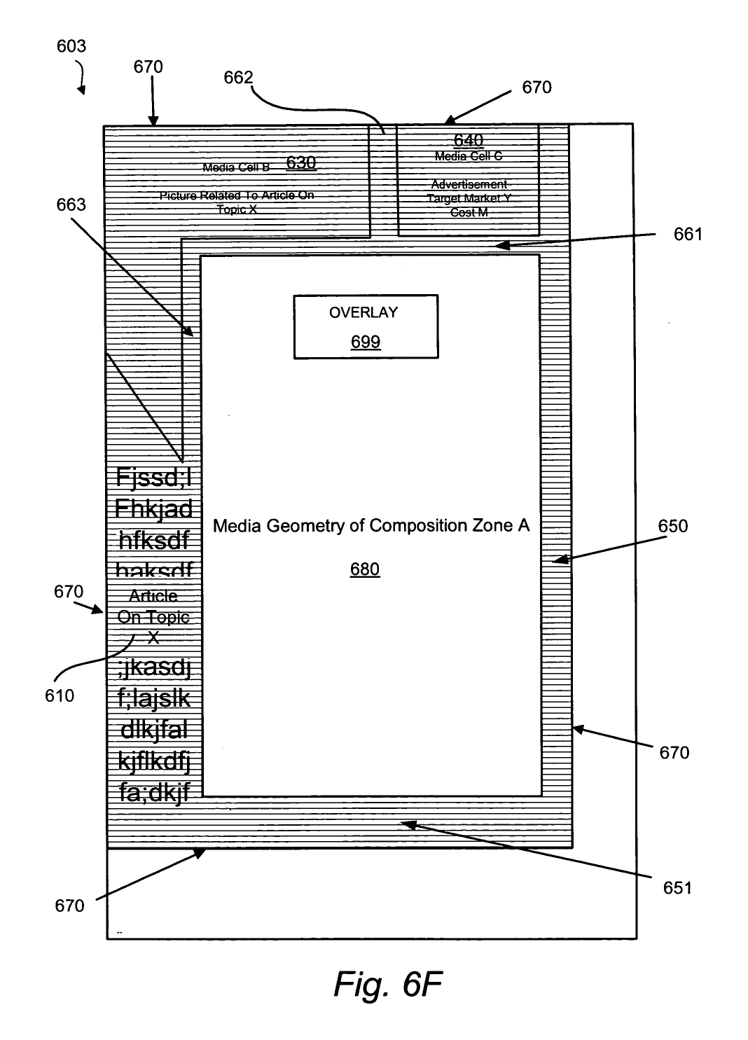

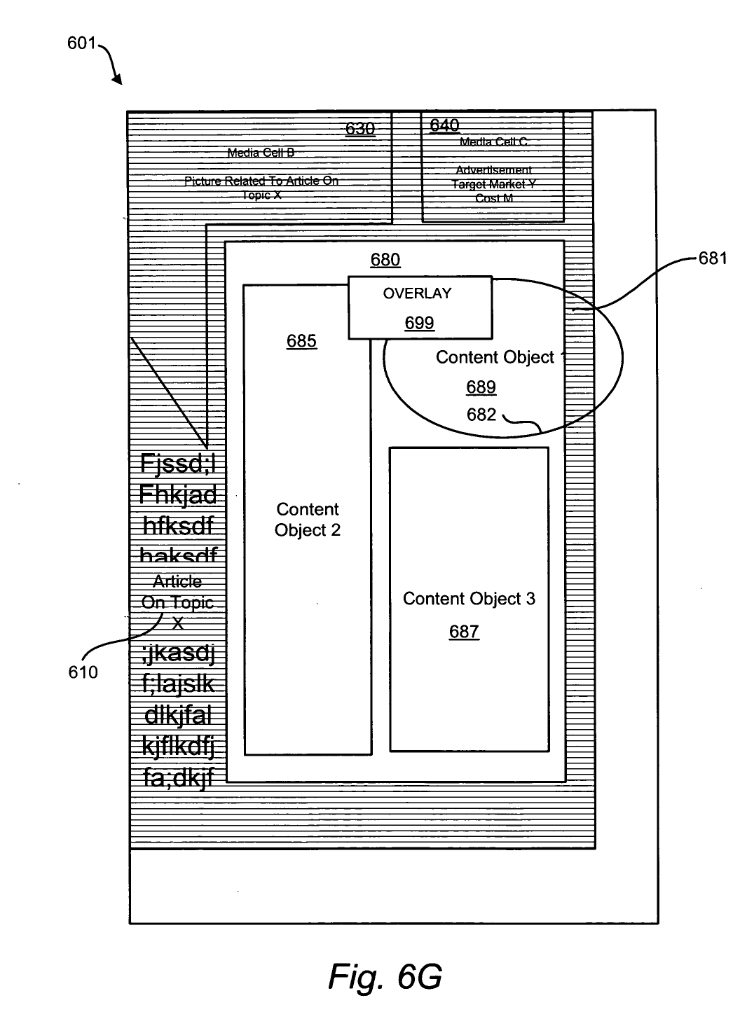

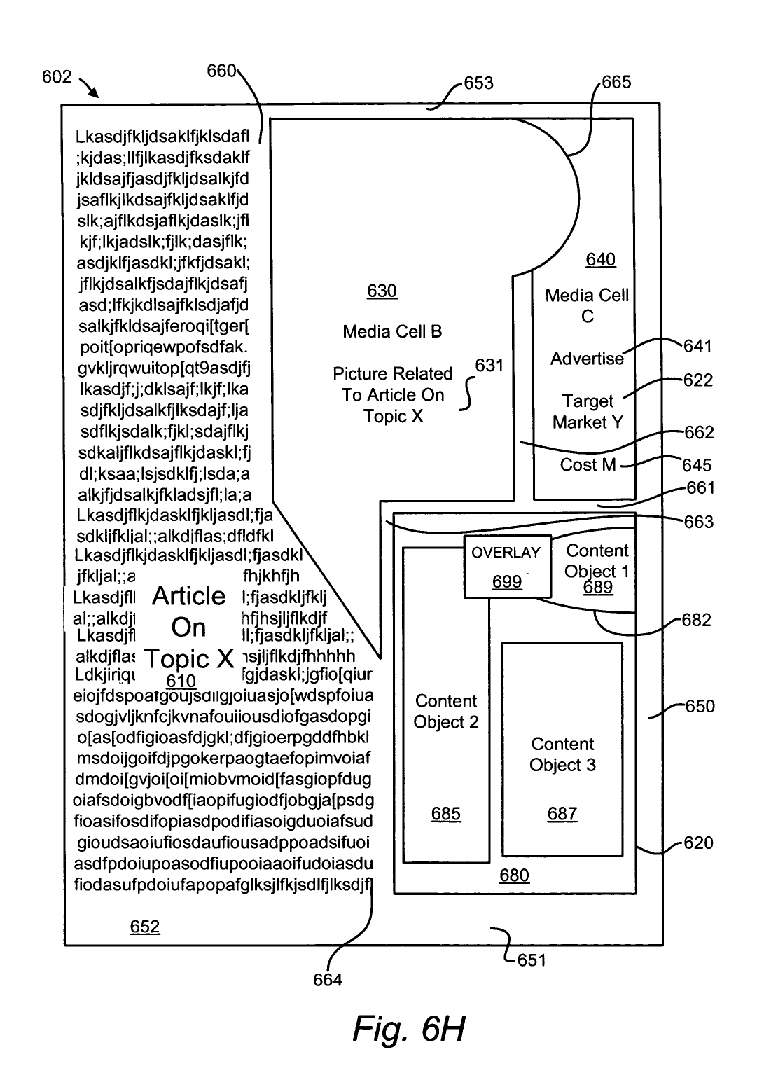

In some cases, composition zones are defined within the overall media production block 233). These composition zones can be used to facilitate parallel media production development and are further described below in relation to FIGS. 5-6. Layouts or compositions can then be received in relation to the respective composition zones (block 236). These layouts can be compared against the job jacket to assure compliance (block 239). Where the layout is inconsistent with that called for by the job jacket (block 239), it is determined if the job jacket can be modified to allow the layout (block 242). Where the job jacket is to be modified (block 242), it is modified (block 248) and a determination is made of whether the layout is consistent with the modified job jacket (block 239). Alternatively, where the job jacket is not to be modified (block 242), the layout is modified (block 245) and the modified layout is again compared against the job jacket to assure compliance (block 239). Based on the disclosure provided herein, one of ordinary skill in the art will appreciate a myriad of other layout modifications that can be made, and/or a variety of job jacket modifications that can be made to facilitate a design in accordance with embodiments of the present invention.

In addition, it is determined if the received layout is consistent with the composition zone to which it corresponds (block 251). Where the layout is inconsistent with the corresponding composition zone (block 251), it is determined if the composition zone can be modified to allow the layout (block 254). Where the composition zone is to be modified (block 254), it is modified (block 260) and a determination is made of whether the layout is consistent with the modified composition zone (block 251). Alternatively, where the composition zone is not to be modified (block 254), the layout is modified (block 257) and the modified layout is again compared against the composition zone to assure compliance (block 251). As just one example, it may be determined whether all elements of a layout are disposed within a media geometry of the respective composition zone. Where one or more of the elements are not so disposed, they can be automatically cropped as more fully described in relation to FIG. 6 below. Based on the disclosure provided herein, one of ordinary skill in the art will appreciate a myriad of other layout modifications that can be enforced, and/or a variety of composition zone modifications that can be made to facilitate a design in accordance with embodiments of the present invention.

Having assured that the overall media production, composition zones and layouts are consistent, all of the layouts are assembled together as indicated by the respective composition zones (block 263), and all of the elements are finally assembled to form the overall media production (block 266). This overall media production can then be released for publication in media defined in the job jacket. As will be appreciated by one of ordinary skill in the art, the method illustrated in FIG. 2 can be used to assure a systematic and effective publication approach. Based on the disclosure provided herein, one of ordinary skill in the art will recognize that flow diagram 200 is merely exemplary of some embodiments of the present invention, and that a variety of other approaches can be assumed to attain a desired goal. As just one example, the layouts can be checked against composition zone definitions before they are checked against the job jacket. As another example, layouts can be checked against both the job jacket and corresponding composition zone in parallel. As yet a further example, composition zones can be defined in the overall media production before the overall media production is compared to the job jacket. Further, there may not be any need to perform a check of a layout against a corresponding composition zone, and if such is the case, that process included in flow diagram 200 can be eliminated.

As previously suggested, producing a successful media production is not a simple task, and often involves a number of entities bringing particular expertise to the development process. It can occur that even where a highly experienced professional is overseeing a particular media production project that significant cost overruns and/or delays can occur due to ambiguous definitions and/of the lack of control in the production process. In part to address this potential, various embodiments of the present invention provide for use of a job jacket or job jacket definition. These can be electronic files associated with input tools for dealing with the significant complexities in the media production process. Thus, various embodiments of the present invention provide a mechanism for receiving resource definitions from a number of entities involved in the media production process. In some cases, these resource definitions are predefined for a particular entity, are not negotiable, and can be incorporated in a job jacket definition. For example, a press may be a four color press capable of using only particular types of paper. Where such a press is selected, the resource limitations of the press are provided by the press and incorporated into a job jacket definition by the entity overseeing development of the media production.

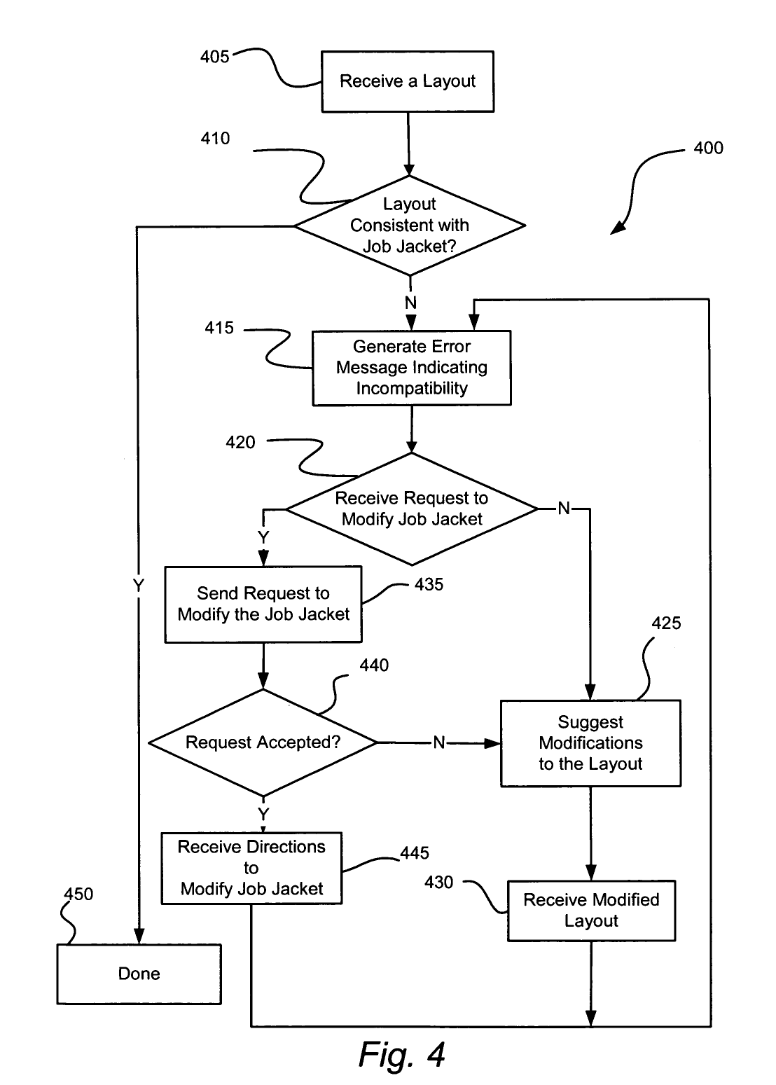

The received resource definitions can be assembled into a job jacket definition that is used to control the media production process. In particular, a job jacket definition or job jacket can be used to indicate the resources that in some cases can be used in relation to a developing a media production (an optional resource), and in other cases that must be used in relation to the media production (a necessary resource). In some cases, embodiments of the present invention also allow for inclusion of job definition statements, job tickets to define desired layouts, specifications that define layouts, rules that regulate design and layout creation processes, and parameters for an end media product. Such information is generically described in relation to FIGS. 3 and 4 as resources.

By setting forth resources available to the media production, layout artists, designers and other entities working on the project can conform to those requirements from the beginning rather than finding out late in the production process that their proposed layout is unacceptable. This can reduce design time, costs and frustrations. In some cases it may be found that additional resources are needed to complete the project. Thus, some embodiments of the present invention provide a mechanism for requesting job jacket modifications.

Turning to FIG. 3, a graphical representation 300 of exemplary entities involved in forming a job jacket definition 310 is presented in accordance with various embodiments of the invention. As illustrated, many entities 312, 314, 316, 317, 318, 319 collectively referred to as stakeholders 315 can interact to form job jacket definition 310. This interaction can bring the stakeholders involved in creating the media production together at an early stage. Early stage definition helps to assure that a proposed media production can actually be produced in an efficient and meaningful way. In particular, job jacket definition 310 can avoid the exemplary problem of spending considerable amounts of time and effort designing only to find out that the design is incompatible with a press or other publishing equipment. Based on the disclosure provided herein, one of ordinary skill in the art will recognize a myriad of other advantages of providing job jacket definition 310 as one of the steps in preparing a media production. It should be noted that in each project stakeholders 315 may interact in different ways. Thus, it should be understood that the order, if any, of stakeholders 315 shown on FIG. 3 may be different depending upon the particular scenario.

In the illustrated embodiment, job jacket definition 310 is created through the interaction of attorneys/accountants 312, suppliers/service providers 314, designers 316, clients 317, advertisers 318, and a media producer 319. Each of these stakeholders 315 bring their particular skill to bare in defining a media production. For example, media producer 319 may have specific information about publishing in a particular medium. Where media producer 319 is a press, media producer 319 can bring expertise on what papers and inks will produce acceptable results on its press. Similarly, advertisers 318 and/or clients 317 may find a need to express a desire for certain types of advertising space allowing the use of selected colors and fonts. Designers 316 may have expertise on how they perceive that the media production should look, suppliers 314 may provide information about costs and availability of materials, and attorneys/accountants 312 can provide expertise about branding, disclaimers, costs and other aspects.

All of this expertise can be formed into job jacket definition 310 that identifies an intent 320. In some cases, this intent is referred to as a layout specification and can be made up of various elements that, in combination, define the overall goal of the job or task and scope of the product to be created. Intent 320 may provide a set of plans or guidelines as well as an opportunity for applications to provide rule sets that check layouts for conflicting properties throughout the content creation cycle. As just one example, intent 320 can indicate a medium in which the media production will be published or deployed. This medium may be, but is not limited to, print, static web, interactive web, video and audio. By defining the media product intent, the job immediately begins to take shape by narrowing the scope of possible variations that can cause misunderstandings, delays and disappointment. In some cases, resources associated with specifications are defined by and extended from the JDF 1.2 specification and represents the bulk of the JDF integration within the Job Jacket implementation.

In addition to intent 320, a number of resources are defined that will limit the universe of materials, content objects, and requirements which a designer will be expected to adhere. As an example, the resources can include, but are not limited to, physical resources 330, electronic media resources 340, layout resources 350 and brand resources 360. Physical resources 330 may include, but are not limited to, paper, inks, colors, fonts, resolution, number of pages, page size, development tools, work flow definition, archival systems, press systems, binder systems, and/or the like. Electronic media resources 340 may include, but are not limited to, readers, players, plug-ins, content object libraries, image resolution, frame rate, and/or the like. Layout resources 350 may include, but are not limited to, pagination, paper folds, binding requirements, trim requirements, tear-out locations, amount of content, amount of advertising, file format, color space, and/or the like. Brand resources 360 may include, but is not limited to, content objects, colors, legal marking, agreement between the director and the client, and/or the like. In some cases, one or more stakeholders responsible for changing a particular resource can be identified in the job jacket. For example, where a branding resource requires the use of a particular disclaimer, the branding resource may also indicate that attorney 312 is responsible for changing requirements related to that resource.

As previously suggested, the resources can further include job jacket definition statements, job tickets to define desired layouts, rules that regulate design and layout creation processes, and parameters for an end media product. Job jacket definition statements can be a high level description of the desired media production. The definition can specify such things as the finished size of the media production after all folding and trimming is complete, the color standard used by the selected press, the binding method used, the stock upon which the media publication will be printed, and/or the like. Alternatively, in the case of an electronic media production, job jacket definition 310 can specify the length or number of bytes associated with the production, display refresh rate, proposed plug-ins or available readers, and/or the like. The job jacket definition can also include contact information for various entities holding a stake in the media production.

Job tickets are templates stored with the job jacket that when augmented with scheduling attributes become tasks that define various sub-projects within the media production project. A job ticket specifies such things as project settings, proposed designer or production artist, a schedule, relevant content objects or other resources particular to the sub-project, layout and output specifications, and/or the like. Job tickets can be instantiated multiple times with each instance having reference to data in the template as well as specialized data that is only used for that specific instantiation. As one example, schedule properties may be specialized data of a single job ticket instance.

The resources can also include various rules to which the design process must conform. When a job is submitted to the service provider, it looks at the output request form and the job specifications and make sure that the publication and that various defined resources (i.e graphics, fonts, layouts, etc) are created appropriately for the pre-press workflow through which it will be processed. In many cases the media production undergoes a series of inspection/ intervention cycles, commonly called pre-fighting. These intervention cycles consist of analysis and modification made by the pre-press specialists or the designer before the media production is ready for final output. In some embodiments of the present invention, the rules can be applied systematically and in some cases in real time to assure that a media production proceeds as prescribed and that the desired media production is recorded. In this way, these embodiments of the present invention provide for limiting the amount of pre-fighting performed while creating a media production.

Even though a layout is constructed according to the various rules and constructions, the selected output format can still cause problems during the pre-press production cycle. Thus, job jacket definition 310 can include an output specification and/or parameters that can be used to assure a proper output product. In some cases, the output parameters can also specify the creation of a JDF job ticket that specifies the product intents used to initiate a JDF enabled workflow automatically.

Turning to FIG. 4, a flow diagram 400 illustrates a method for governing media product development in accordance with one or more embodiments of the present invention. Following flow diagram 400, a proposed layout is received (block 405). The proposed layout is intended for inclusion in a media production corresponding to job jacket definition 310. It is determined whether the proposed layout conforms to the job jacket definition (block 410). As one example, to make this determination, a computer may form a list of all resources utilized in forming the layout. This list is compared against the list of resources identified in job jacket definition 310. Thus, for example, a layout may indicate the use of a magenta background (an optional resource). It is determined if the available inks can create the prescribed background color, or if the color is defined as available in job jacket 310. Where the color is available, and all other resources required by the layout are available, the layout is accepted and the process completes (block 450). As another example, it may be determined whether the layout includes prescribed legal disclaimers (a necessary resource). Where the presented disclaimer is included and all other resources conform with job jacket definition 310, the layout is accepted and the process completes (block 450).

Where an optional resource is used in a layout but is not included in job jacket definition 310, or where a necessary resource is not included in the layout, an error message is generated indicating the incompatibility (block 415). At this juncture, the presenter of the layout can request a modification to the job jacket definition that would allow the layout, or the presenter can modify the layout and resubmit it for consideration. To this end, it is determined if the presenter has made a request to modify the job jacket definition (block 420). Where no request is received to modify the job jacket definition (block 420), a suggested change to the layout can be provided (block 425). Thus, for example, it may be suggested that the magenta color be changed to red, or that the proper legal disclaimer be selected from a content object database and included in the layout. Once the change has been made, the modified layout is received (block 430). This modified layout is then verified using the previously described process.

Alternatively, where a request to modify the job jacket definition is received (block 420), an entity controlling the job jacket definition is contacted with the modification request (block 435). Thus, for example, where the designer submits a layout without a required disclaimer, attorney 312 responsible for controlling use of the disclaimer would be contacted to determine whether the disclaimer can be omitted. Alternatively, where the disclaimer is included, but in a font different from that specified, attorney 312 can be contacted to request a change in the job jacket. Based on this disclosure, one of ordinary skill in the art will recognize a number of different change requests, and stakeholders 315 that could be contacted in relation to such change requests. Further, the entity may contact one or more experts involved in forming the job jacket definition to determine whether the requested change is acceptable. In some cases, this process is all handled online and in real time. Such a request to change the job jacket definition can be electronically communicated to one or more entities responsible for maintaining the job jacket definition, and in return one or more of these entities can respond either accepting or declining the request. Where the request is declined (block 440), a layout modification is suggested and the presenter is expected to modify the layout as previously described in relation to blocks 425-430.

Alternatively, where the modification to the job jacket definition is accepted (block 310), the job jacket definition is modified to either indicate an additional optional resource, or to eliminate a necessary resource (block 445). In some cases, this change can be done automatically and in confromance with the request, or directly by the stakeholder approving the request. With this done, the layout is again verified to assure compliance with the job jacket definition (block 410) and the process continues as previously described.

Some embodiments of the present invention allow users to define composition zones and/or media cells. In some cases, the definition of a composition zone and/or media cell is accomplished by drawing a shape or line that defines an area in which a layout will be presented. This shape may encompass text, graphics, boxes, tables, sub-composition zones, or other representations made by a layout artist. In some cases, a composition zone including a layout provided in relation to the composition zone can be treated as an asset and reused in other media productions, or checked out of the media product for editing or creation by another user or entity.

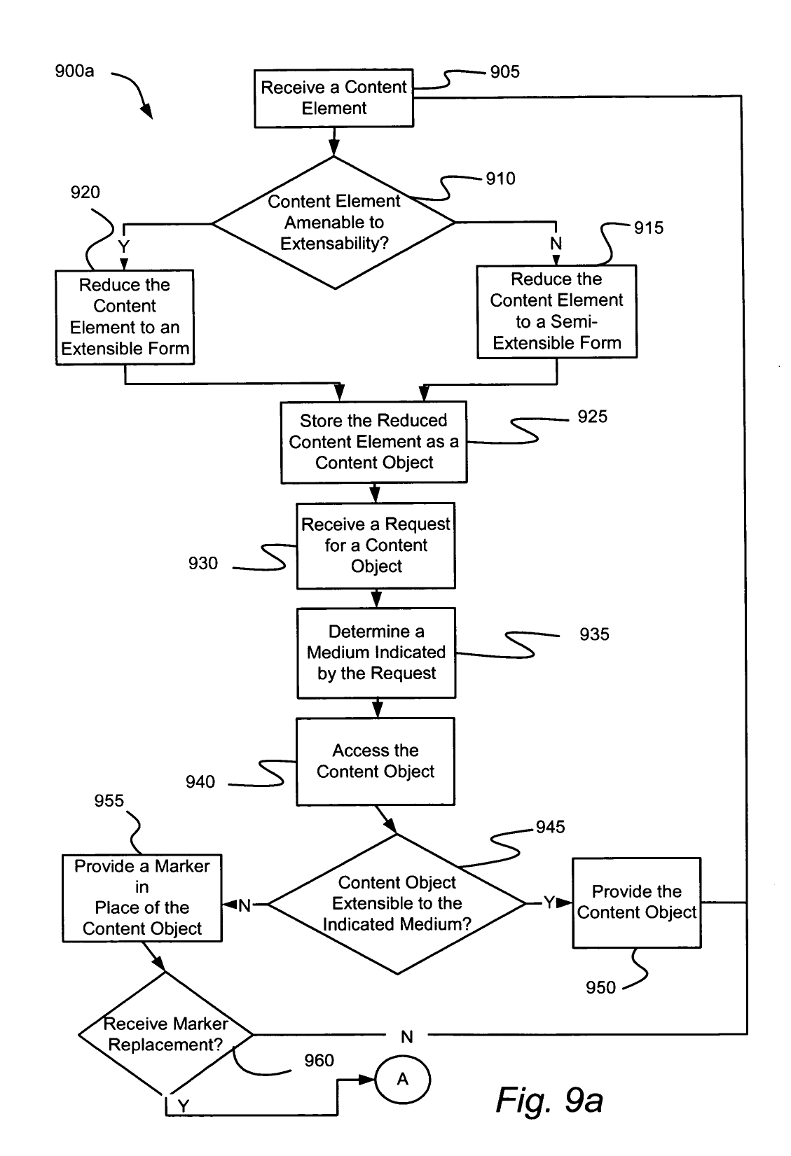

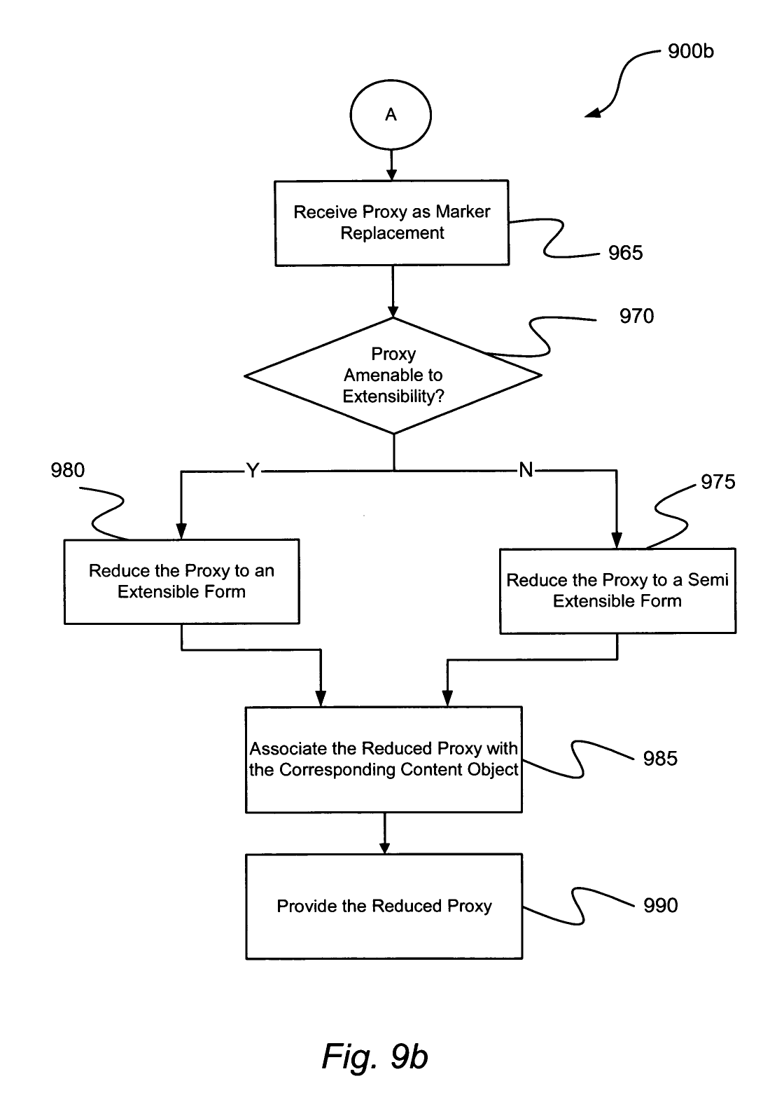

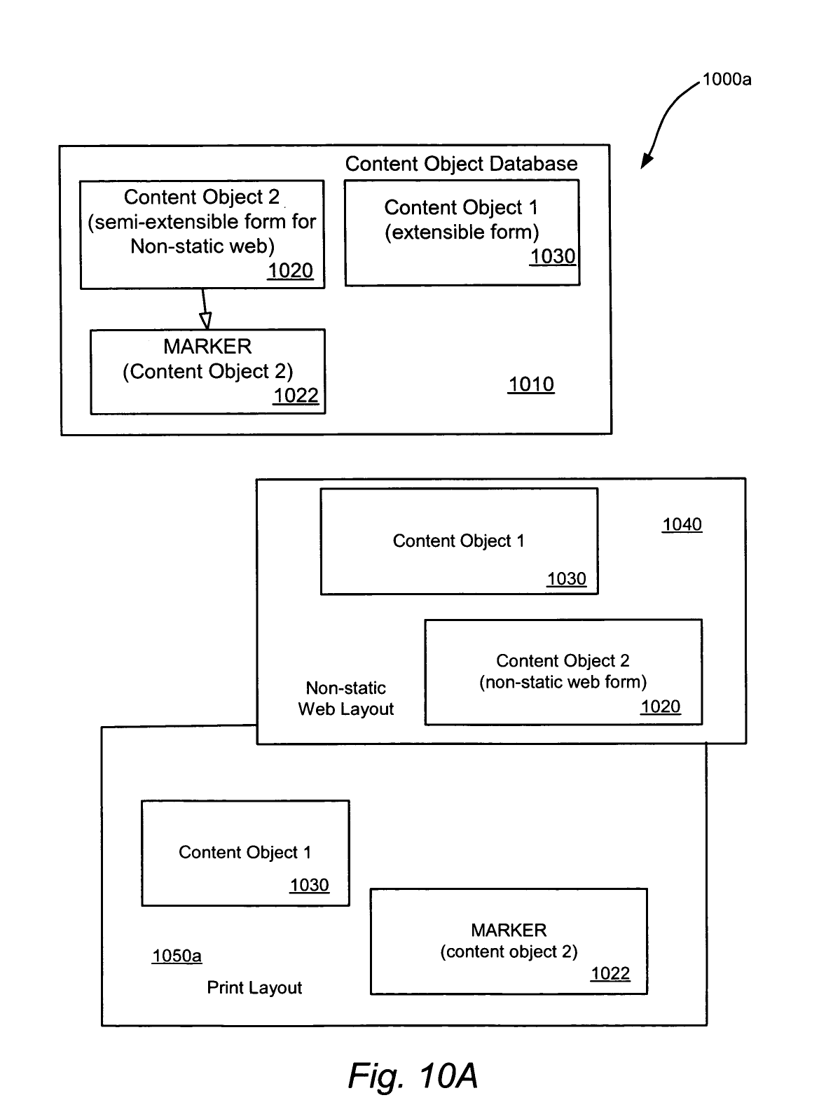

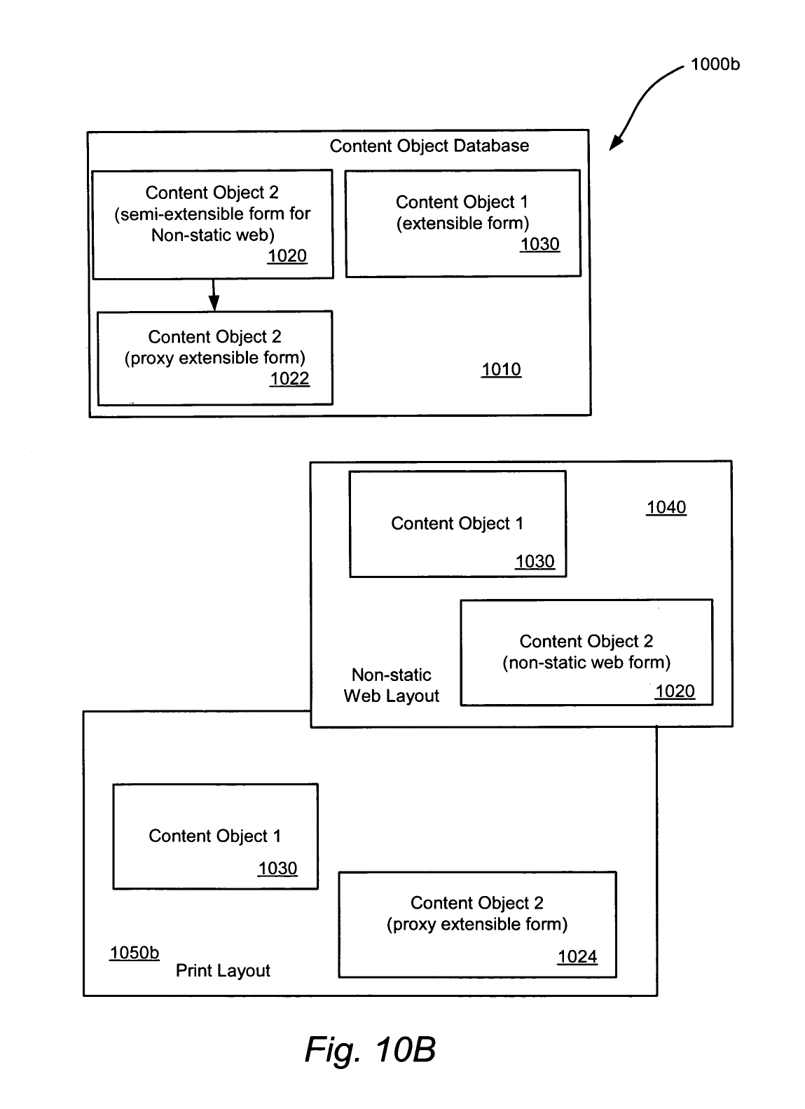

In some cases, a composition zone can be defined as a content object and maintained in a content object database. In such a case, the composition zone may be reduced to an extensible or semi-extensible form as more fully discussed below in relation to FIGS. 9-10 below. As just one example, such an approach of maintaining a composition zone including associated design elements as a content object allows an advertisement designed for one media production to be re-purposed for use in another media production of the same or different media. While each publication may require that the advertisement contain unique attributes such as size position and text, the bulk of the content in the advertisement may be very consistent from one media production to another, thus making re-purposing even more valuable. In some instances of the present invention where a composition zone is maintained as a content object, it can be re-purposed for deployment in relation to a variety of media cells.

In various cases, design and/or layout can be performed on a number of composition zones and an encompassing media product in parallel. Thus, for example, two composition zones can be defined for two different advertisements. An advertiser purchasing one of the composition zones can prepare its advertisement at the same time another advertiser is preparing a design for the other composition zone. This parallel production ability can facilitate a significant reduction in media production development time and cost.

Further, in some cases a composition zone can include a context that allows a designer or other entity to understand the surroundings in which their composition or layout will be deployed. This can aid in laying out more effective designs. In some cases, this context information can be updated as layouts associated with other composition zones and other portions of the media production become available. In some particular cases, updating of context information can be performed in real time.

Turning to FIG. 5, a flow diagram 500 illustrates a method utilizing composition zones in accordance with some embodiments of the present invention. Following flow diagram 500, a media production is defined (block 510). This can include, but is not limited to, providing a high level layout of a magazine page(s), news paper page(s), web page(s), audio program, video program, or other media layout. One or more media cells are defined (block 520). Such media cells can be a portion of the defined media production. Thus, as just one example, a media cell can-be an open area where an advertisement will be placed on a magazine page. Based on the disclosure provided herein, one of ordinary skill in the art will recognize a myriad of media cells that can be defined in accordance with embodiments of the present invention.

A composition zone can be defined in relation to a respective media cell (block 530). This can include defining various parts of the composition zone including a geometry in which a design will be placed (i.e., media geometry), and in some cases context surrounding the media cell. Such context is further described below in relation to FIG. 6. This composition zone definition can be used to graphically display a composition zone (block 540). The graphically displayed composition zone can be used by a designer or other entity to prepare a layout. This layout can be associated with the media cell corresponding to the composition zone. The design created in relation to the composition zone is received (block 550), and the design is portrayed in the location associated with the media cell of the media production (block 560). Further, in some cases, the layout can be checked against design limits and/or resources provided in relation to a job jacket as previously described. Where a problem is identified, it can be cured early in the design process, rather than on the eve of publishing the media production.

Turning to FIG. 6, an exemplary page layout 600 is provided to illustrate various embodiments of the present invention. Page layout 600 can be designed by a production artist or another entity and can be tailored for display on one or more media and/or one or more media productions. For example, page layout 600 can be tailored for display on a printed magazine page, on a website page, on a newspaper page, as one or more frames of a video segment, or as part of some other media production. Page layout 600 includes three media cells 620, 630, 640. Each of the media cells are associated with composition zones as further described below.

In this case, page layout 600 includes a variety of information useful for understanding the purpose of each of the media cells. For example, page layout 600 includes an area set aside for an article on topic X 610. Further, one or more of media cells 620, 630, 640 can include intent information. For example, media cell A 620 includes an indication that the media cell is to be used as an advertisement 621, with a target advertising market Y 622, and a purchase cost Z 623. As another example, media cell B 630 includes an indication that it is to be a picture or image related to the article on topic X 631. As yet another example, media cell C 640 includes and indication that the media cell is to be used as an advertisement 641, with a target advertising market Y 622, and a purchase cost M 645. The target advertising market can be, for example, a market of individuals, advertisers and/or companies that may share a particular interest in topic X.

In some cases, such intent information can be used in relation to marketing space represented by the various media cells. It may be that an advertiser is willing to pay more for space when they know that particular content such as the article 610 will be near the purchased space. Some embodiments of the present invention allow for the various spaces on page layout 600 to be substantially defined very early in the media production process. This early stage may allow for advertising profit margins to be maximized. Advertising may be sold long before the article or content associated with various media cells is finalized.

Page layout 600 also includes a variety of definitional information. This definitional information can include, but is not limited to, outer page margins 650, 651, 652, 653. These margins can, for example, account for page trim, fold, and/or other characteristics. Other examples of definitional information includes spacing between media cells 660, 661, 662, 663, 664, 665. Such spacing can vary from zero to any distance, and in some cases can account for ink bleed characteristics and/or aesthetic characteristics.

As previously suggested, page layout 600 may include a variety of elements and definitions that in some cases are associated with a composition zone whether they be as context or part of the media geometry of the composition zone. In some cases, the media geometry is referred to as a media box, and can be of any shape or size, but is often rectangular in shape. As just some examples, a page layout can include a variety of boundary specifications including, but not limited to, a crop box, a bleed box, and a trim box.

A bleed box defines an area that is to be clipped in the media production. This bounding box is useful to composition zones related to media cells. For example, a composition zone that falls within all sides of a media cell defined to be the page of a print publication would use a trim box for its display area. If a composition zone comes in contact with one or more sides of the media cell's trim, then the display area of that composition zone may extend to the bleed box defined for the media cell.

A trim box defines the intended dimensions of the finished composition zone. As an example, where the composition zone encompasses an entire page of a printed publication, then the trim box defines the finished dimensions of that page after any folding and triming. In some cases, the trim box can also indicate the default display area for a composition zone. A crop box is a clipping path that defines the display area of a composition zone. The crop box can apply to the media box,.bleed box, or trim box. The crop box may use the trim box by default but can be changed to any other bounding box or path on an instance by instance basis.

Other examples include a binding intent that identifies the type of binding specified, and the side on which the binding is to be applied. This binding intent can in some cases impact a composition zone. For example, when two media cells come together at the spine, a trim box associated with a composition zone near the spine the composition zone's trim box may change size to accommodate creep or binding gutter.

As yet another example, a folding intent can be included that identifies the type of folding specified on any given media production. Like the binding intent, the folding intent can also have an impact on media cells and composition zones. As a particular example, where two composition zones are to be located next to one another, a trim box can be defined in relation to each of the composition zones to accommodate the hold-back from the face trim. In some cases, the folding intent is defined as part of a job jacket as discussed above. In some embodiments, page layout 600 can be at least in part defined by a layout intent that defines the dimensions of the finished page of the media production after any folding and/or binding. Such a layout intent can also be defined as part of a job jacket.

Based on the disclosure provided herein, one of ordinary skill in the art will recognize a variety of information that can be included to describe the intent of media cells. Further, based on the disclosure provided herein, one of ordinary skill in the art will recognize that in some instances of the present invention no information related to the intent of a media cell is included. Also, based on the disclosure provided herein, one of ordinary skill in the art will recognize that media cells can be defined in a variety of shapes including straight and curved area boundaries. Further, such media cells can be a portion of a page, the entire page, or multiple pages. As just some other examples, a media cell can be a tear-out to be included in a magazine, a product package or portion thereof, a website or portion thereof, a video segment, an audio segment, or the like.

Turning to FIG. 6B, media cells 620, 630, 640 can be associated with composition zones. In particular, composition zone 601 is associated with media cell 620. Composition zone 601 can be provided to a designer or other entity responsible for the content of media cell 620. As illustrated, composition zone 620 includes a media geometry 680 that defines the area in which the designer places his design. In addition to media geometry 680, composition zone 601 may have a variety of context 670 surrounding media geometry 680. Such context can be used by a designer to design in relation to the areas that will be surrounding media geometry 680 when it is deployed.

In some cases, context 670 is completely defined when the designer is preparing his layout in media geometry 680, and in other cases it only includes whatever descriptive information was available from page layout 600 when it was originally defined. In various cases, context 670 is synchronized to the media cells and other areas which it represents. Thus, when another entities is preparing a design for another media cell and/or article surrounding media geometry 680, that design information can be updated and included in context 670 as it becomes available. Similarly, in some cases, a layout provided in relation to media geometry 680 or portion thereof can be included with the context of another composition zone associated with another media cell.

As illustrated, context 670 includes the portion of media cell B 630 and that of media cell 640 that surrounds media geometry 680. In addition, the descriptive information about the media cells is included. As previously discussed, as much information about the surrounding media cell as is available up to the completed design may be included as context 670. Context 670 also includes article 610 that can be represented by dummy text, or where available, actual article text. Further, context 670 can include various spacing information 661, 662, 663, 651, 650 that represents the areas surrounding media geometry 680.

Turning to FIG. 6C, composition zone 601 is shown after a designer or other entity has prepared a layout included in and about media geometry 680. In particular, a content object 685 and a content object 687 are included at respective positions within media geometry 680. Further, a content object 689 is included partially within media geometry 680 with a portion 682 within media geometry 680, and another portion 681 located outside media geometry 680. Once completed, composition zone 601 can be included within media cell A 620 with which it is associated. FIG. 6D shows composition zone 600 updated to include the layout provided in relation to composition zone 601. As illustrated, the layout including content objects 685, 687, 689 shown as they will be when page layout 600 is implemented as a media production. Of note, only portion 682 within media geometry 680 is included in the layout.

Turning to FIGS. 6E-6H, a page layout 602 and a composition zone 603 are described. Composition zone 603 and page layout 602 are very similar to those described in relation to FIGS. 6A-6D, except that an overlay 699 is added. In particular, referring to FIG. 6E, overlay 699 consumes a portion of media cell A 620. In some cases, overlay 699 is another layout object placed over media cell 620, while in other cases, overlay 699 is a carved out area of media cell 620. Overlay 699 can be defined as an area where part of Article 610 is to be placed, or it can be another media cell. As shown in FIG. 6F, overlay 699 is included as part of the context of composition zone 603 allowing a designer acting with composition zone 603 to consider overlay 699 and in some cases the contents thereof when designing a layout tailored for the composition zone.

In some cases, overlay 699 is defined after a design for composition zone 603 has already been completed. In such a case, composition zone 603 including the layout in media geometry 680 are modified to include overlay 699 as depicted in FIG. 6G. In some cases, the design may also have been updated to page layout 602 as shown in FIG. 6H. A designer of the layout associated with media geometry 680 may desire to go back in an modify the design to account for overlay 699, or may leave the design as is. Alternatively, where overlay 699 undermines the provided layout, the designer may simply delete the previous design and start over with an understanding that overlay 699 will be included at the presecribed location of the composition zone. Based on the disclosure provided herein, one of ordinary skill in the art will appreciate that a number of overlays can impact a composition zone, and that the overlays can be defined before, during or after a design associated with the composition zone is completed.

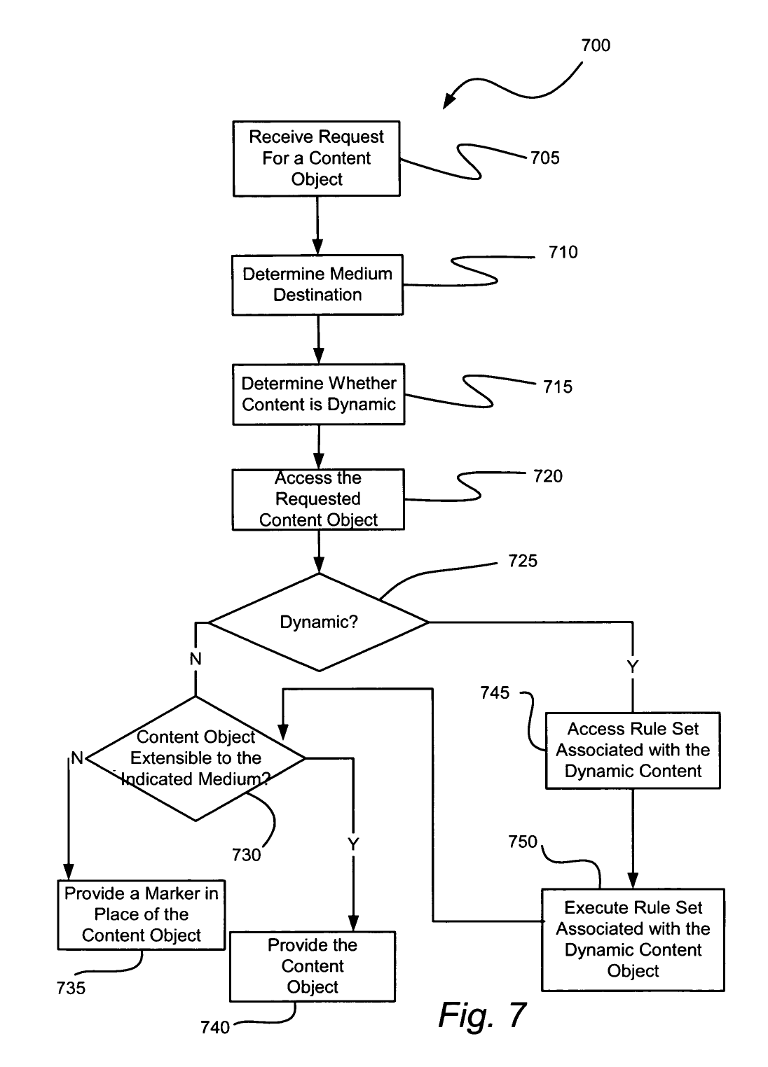

Turning to FIG. 7, a flow diagram 700 illustrates a method for re-purposing content objects in accordance with various embodiments of the present invention. Following flow diagram 700, a request for a content object is received (block 705). In some embodiments it is determined in what medium the requested content object will be deployed (block 710). In some cases, this information is provided via a user requesting the content object, while in other cases, this information can be derived from a job jacket definition associated with a media production in which the content object is to be deployed. In some cases, this information is not provided, but rather the request indicates that the end medium has not yet been selected.

In addition, it can be determined whether the requested content object is dynamic (block 715). With this determined, the requested content object is accessed from a content object set or database (block 720). Where the requested content object is not dynamic (block 725), it is determined if the content object is extensible to the indicated medium (block 730). Where the content object is extensible to the medium (block 730), the requested content object is provided (block 740). Alternatively, where the content object is not extensible to the medium (block 730), a marker is provided in place of the content object (block 735).

Where the requested content object is dynamic (block 725), a rule set associated with the content object is accessed (block 745). This rule set is applied to the content object to form it into a deployable content object. It is also determined whether the content object is extensible to the indicated medium (block 725). Where the content object is extensible to the medium (block 730), the requested deployable content object is provided (block 740). Alternatively, where the content object is not extensible to the medium (block 730), a marker is provided in place of the content object (block 735).

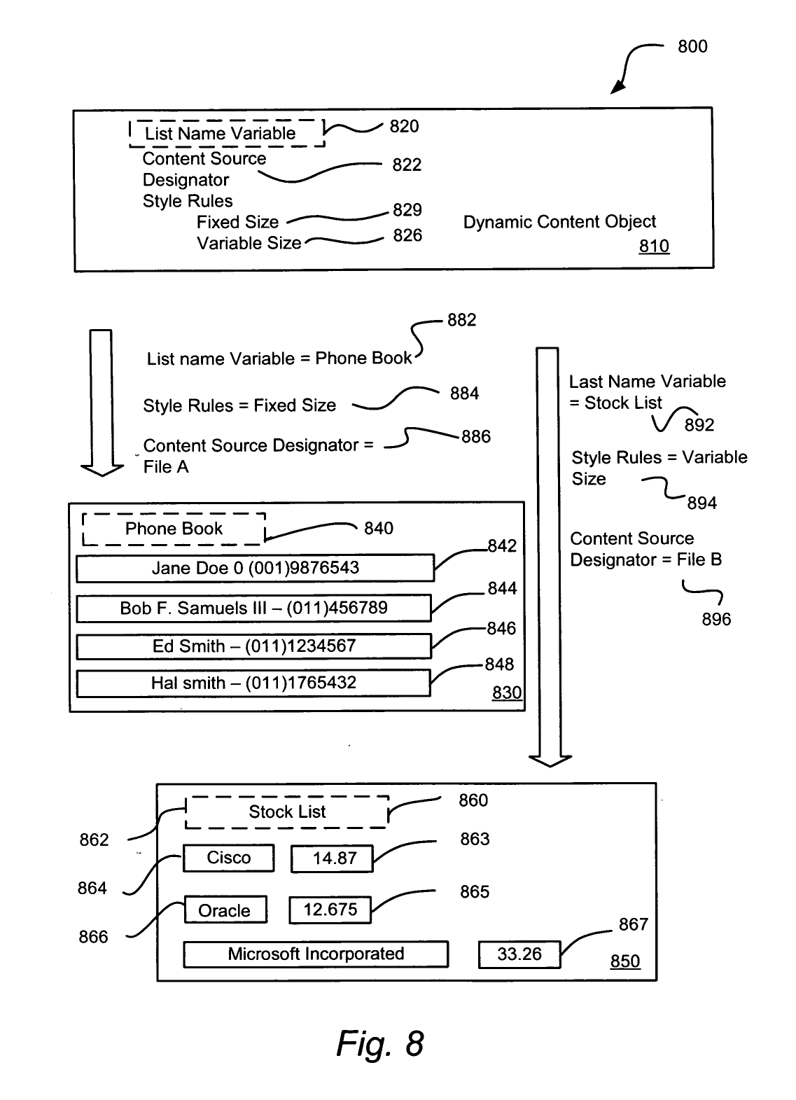

Turning to FIG. 8, a graphical depiction 800 illustrates an exemplary use of a dynamic content object 810 in accordance with various embodiments of the present invention. Dynamic content object 810 includes a list name variable 820, a content source designator 822, a fixed size style rule 824 and a variable size style rule 826. When dynamic content object 810 is requested, the request includes a list name 882, a style rule selection 884, and a location of the content source 886. These inputs are used to form dynamic content object 810 into a deployable content object 830. As illustrated, deployable content object 830 includes list name 882 in a field 840 corresponding to list name variable 820. In addition, a list of names and phone numbers 842, 844, 846, 848 gathered from content location source 886 are displayed in a fixed field length corresponding to the selected fixed field size designator 884.

As another example, When dynamic content object 810 is requested, the request includes a list name 892, a style rule selection 894, and a location of the content source 896. These inputs are used to form dynamic content object 810 into a deployable content object 850. As illustrated, deployable content object 850 includes list name 892 in a field 860 corresponding to list name variable 820. In addition, a list of company names and corresponding stock values 862, 863, 864, 865, 866, 867 gathered from content location source 896 are displayed in a variable field length corresponding to the selected variable field size designator 894.

Turning to FIG. 9, a flow diagram 900 illustrates a method for storing and maintaining extensible and semi-extensible content objects in accordance with some embodiments of the present invention. Following flow diagram 900, a content element is received (block 905). As used herein, a content element is any form of content that is typically in a format extensible to particular media. In some cases, the content is extensible to a large variety of different media, while in other cases, the content is only extensible to one medium. It is determined if the received content element can be modified to make it extensible to all supported media, or whether it can only be extensible to a subset of the supported media (block 910). Thus, for example, where the content element is a text file tailored for display using a particular word processor, it is possible to modify the content element such that it can be accessed as text that can be deployed in a number of end media. Based on this disclosure, one of ordinary skill in the art will recognize a number of modifications that can be made to content elements to extend their extensibility.

Where it is possible to make the content element extensible to all supported media (block 910), the content element is reduced such that it assumes a form amenable to all supported media (block 920). Alternatively, where it is only possible to make the content element extensible to a subset of the supported media (block 910), the content element is reduced to so that it can be deployed and/or translated for use in the possible media (block 915). The reduced content element is then stored as a content object within, for example, a content object database (block 925). An indication of the extensibility or lack thereof of the stored content object is maintained with the content object.

At some point, a request for the stored content object is received (block 930). In some embodiments it is determined in what medium the requested content object will be deployed (block 935). This information may be provided via a user requesting the content object, while in other cases, this information can be derived from a job jacket definition associated with a media production in which the content object is to be deployed. In some cases, this information is not provided, but rather the request indicates that the end medium has not yet been selected. The requested content object is accessed from a content object database (block 940), and it is determined whether the content object is extensible to the indicated medium (block 945).

Where the content object is extensible to the medium (block 945), the requested content object is provided (block 950) and the process ends. Alternatively, where the content object is not extensible to the medium (block 945), a marker is provided in place of the content object (block 955). In some cases, a user requesting the content object may provide a proxy for the content object for use in the selected medium. Thus, for example, where the indicated medium is print and the selected content object is a video clip that is not extensible to print the user may select a frame of the video clip for display whenever the content object is selected for deployment in a print media. Thus, rather than making the actual content object extensible, a proxy of the content object can be provided to increase the extensibility of the content object.

Thus, it is determined whether a proxy for the content object has been received (block 960). Where one is not received (block 960), the process ends. Otherwise, the proxy is received as a replacement for the received marker (block 965). It is then determined if the received proxy can be extensible to all supported media not currently serviced by the content object (block 970). Where this is possible, the proxy is reduced to make it extensible to at least the additional media (block 980). Alternatively, where it is only extensible to some subset of the remaining supported media, the proxy is reduced such that it is extensible to as many additional media as possible (block 975). The reduced proxy is associated with the corresponding content object (block 985), and it is provided to the requestor of the content object (block 990).

Based on the preceding disclosure, one of ordinary skill in the art will recognize that a user can request a content object that is not extensible to an indicated medium. The user can accept the marker in place of the content object for place holder purposes, and later another entity may provide a proxy extensible to the indicated medium. In such a case, the proxy can be automatically updated to replace the marker. Further, in some embodiments of the present invention, whenever the content object is requested it is provided whenever it is extensible to the indicated medium and the proxy (or one of the proxies where multiple have been provided) is only provided when the content object is not extensible to the indicated medium. Thus, a hierarchical selection rule can be imposed that requires use of the content object where possible, followed by use of the first entered proxy where possible, followed by use of the third entered proxy and so on. At some point, whether it be with one or more proxies) the content object becomes extensible to all supported media and no additional proxies are associated with the content object. Of course, other proxies can be made and stored as stand alone content objects, and a proxy associated with a content object can be saved itself as a content object.

Turning to FIG. 10, a graphic portrayal 1000 is provided of an exemplary re-purposing of content objects in accordance with one or more embodiments of the present invention. Graphical portrayal 1000a shows a content object database 1010 with two content objects. The first content object 1020 is semi-extensible and can only be used in non-static web media. Such a content object could be, for example, an animation. A marker 1022 is associated with content object 1022 whenever a medium is indicated to which content object 1022 is not extensible. In contrast, the second content object 1030 is extensible to all supported media.

A layout 1040 directed a non-static medium is created using both content object 1020 and content object 1030. In this cases, both content object 1020 and content object 1030 are extensible to the indicated medium. Thus, both content object 1020 and content object 1030 are provided for use in layout 1040. In contrast, a layout 1050a is created that is directed to a print medium. In this case, content object 1020 is not extensible to a print medium and thus marker 1022 is provided in its place. As content object 1030 is extensible to the print medium it is provided. Turning to FIG. 10b, a proxy 1024 of content object 2 is provided. Proxy 1024 is extensible to the print medium, and thus in layout 1050b proxy 1024 is provided in place of marker 1022 of layout 1050a.

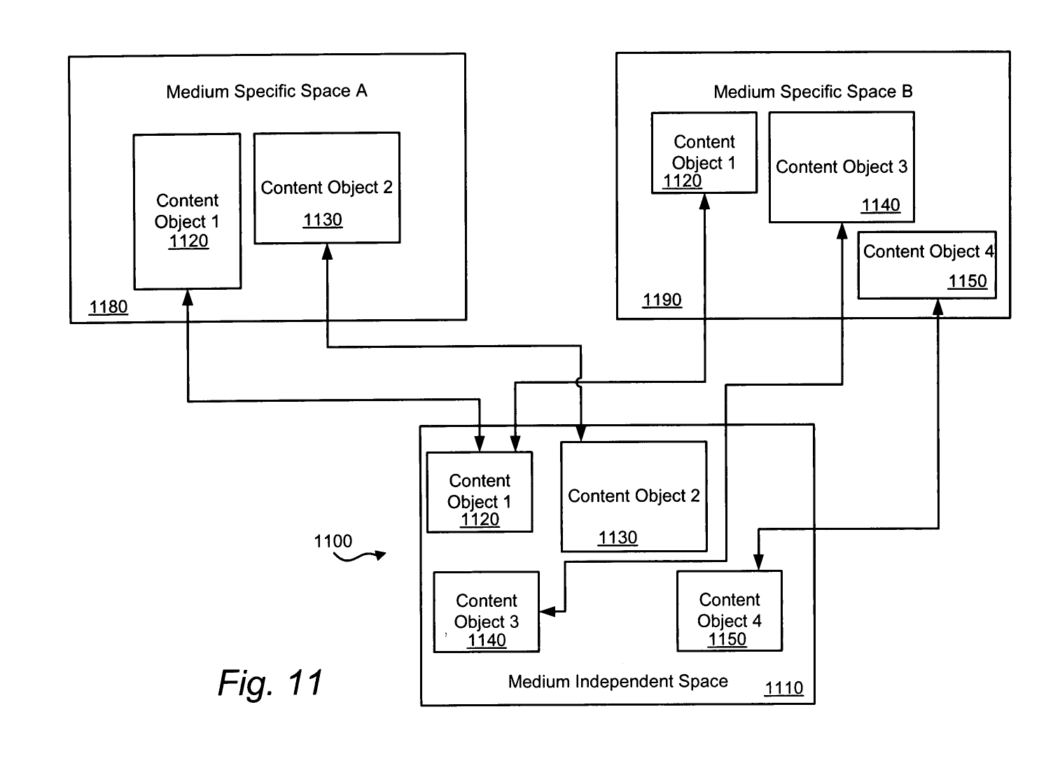

Turing to FIG. 11, a graphic 1100 shows an exemplary synchronization of content objects across various media in accordance with some embodiments of the present invention. A layout is designed in a medium independent space 1110 that includes content object 1120, 1130, 1140, 1150. In some cases, medium independent space 1110 is very rich as all content objects may be displayed therein. In contrast, media specific space can only display content extensible to the particular format. Of the content objects in media independent space i 110, content objects 1120, 1130 are synchronized as indicated by the bi-directional arrows, and content objects 1140, 1150 are not synchronized as indicated by the lack-of arrows. Thus, when a change is made to content object 1120, it is reflected in whichever layouts (e.g., layout 1110, layout 1180 and layout 1190) that the content object has been deployed. In contrast, where changes are made to content objects 1130, 1140 the changes would not be reflected in whichever layouts (e.g., layout 1190) that content object 1140 is deployed. It should be noted that in some cases the modifications to a content object are entered when working in media independent space, while at other times the modifications are entered in media specific space. Where communications are bi-directional and the content object is synchronized, modifications made in either space are reflected across all spaces.

Further, it should be noted that a content object may be implemented differently depending upon the media space in which it is deployed. Thus, for example, content object 1120 may display differently in each of medium independent space 1110, medium specific space 1180, and medium specific space 1190. The manner which the content object is displayed is governed by medium rules associated with each of the spaces. As one particular example, where content object 1120 is a TIFF image displayed in medium independent space 1110, it may be a GIF image of a different resolution in medium specific space 1180, and a JPG image with yet another resolution in medium specific space 1190. Based on the disclosure provided herein, one of ordinary skill in the art will recognize a variety of different medium rules that can be employed in accordance with embodiments of the present invention to deploy content objects across mediums.

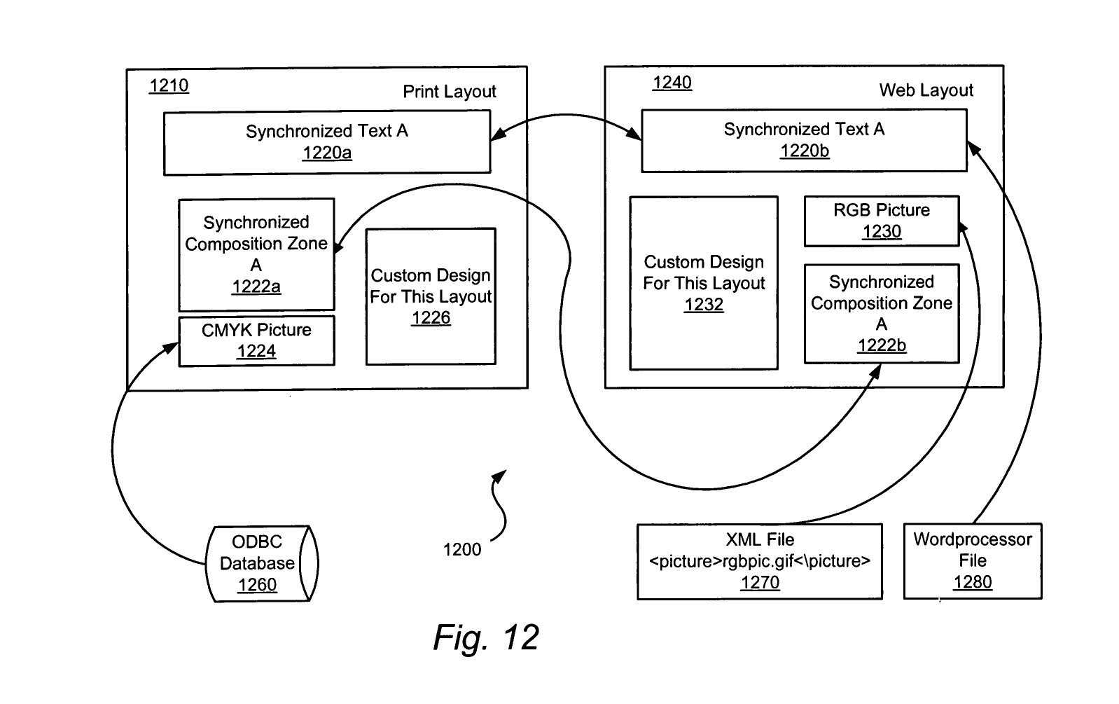

Turning to FIG. 12, a graphic 1200 depicts an exemplary synchronization of content objects and composition zones across various media in accordance with one or more embodiments of the present invention. Graphic 1200 shows two layouts: a layout 1210 directed at a print medium, and a layout 1240 directed at a web medium. Each layout uses a number of content objects and/or composition zones. Some of these items are synchronized across both layouts. In particular, layout 1210 includes a text content object 1220a that is synchronized in we layout 1240 as content object 1220b. The underlying content object 1220 is maintained as a word processor file 1280 at some location. Because of the synchronization, any changes to content object 1220 will be reflected in both layouts 1210 and 1240. In addition, each layout 1210, 1240 uses a composition zone 1222. Composition zone 1222 can be checked out and modified by a user. When these modifications are received, they are reflected in both layout 1210 and 1240 because of the synchronization.

Layout 1210 includes a picture 1224 in a particular graphics format that is maintained on a database 1260, and layout 1240 includes a picture 1230 in another graphics format that is maintained as an XML file 1270. It may be that both pictures 1224, 1230 are identical except for the format, but because the pictures are not synchronized a change to one picture will not be reflected in the other. As previously discussed, where pictures 1224, 1230 were in fact identical, it may be advantageous to reduce the pictures to a format that is extensible across the media represented by layout 1210 and layout 1240. Also, layout 1210 includes a custom design 1226 unique thereto. Similarly, layout 1240 has a custom design 1232. These custom designs are not synchronized and thus changes therein are not reflected outside of the corresponding layout 1210, 1240.

In conclusion, the present invention provides novel systems, methods and arrangements for preparing, planning, creating, designing, and/or distributing media publications and processes related thereto. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for producing a media product, the system comprising:
a microprocessor based controller, wherein the microprocessor based controller is communicably coupled to a computer readable medium, and wherein the computer readable medium includes:
a content object set; and
an instruction set, wherein the instruction set includes instructions executable by the microprocessor based controller to:
receive a job definition;
receive a composition zone definition;
receive a layout definition, wherein the layout definition defines a layout including at least one content object from the content object set; and
export a product in accordance with the job definition and the layout definition to a first media and to a second media.

2. The system of claim 1, wherein the job definition identifies a set of resources for use in creating the product.

3. The system of claim 2, wherein the set of resources includes resources selected from a group consisting of: physical resources, electronic media resources, layout resources, and a brand resource.

4. The system of claim 3, wherein the physical resources include resources selected from a group consisting of: a paper, a set of inks, a set of fonts, and an image resolution.

5. The system of claim 3, wherein the electronic media resources include resources selected from a group consisting of: an execution tool, and a frame rate.

6. The system of claim 5, wherein the execution tool is selected from a group consisting of a reader, and a plug-in module.

7. The system of claim 3, wherein the layout resources include resources selected from a group consisting of: pagination, paper folds, image resolution, a tear-out location, and an amount of advertising.

8. The system of claim 3, wherein the brand resource includes one or more content objects included with the content object set.

9. The system of claim 1, wherein the composition zone definition includes at least one of a size of a composition zone, a location of the composition zone, and a geometry of the composition zone.

10. The system of claim 1, wherein the composition zone definition includes a first geometry of the composition zone for the first media, and a second geometry of the composition zone for the second media.

11. The system of claim 9, wherein the composition zone definition further includes a context of the composition zone.

12. The system of claim 11, wherein the context is selected from a group consisting of: an abstract of an article located near the composition zone, and a visual mockup of an area surrounding the composition zone.

13. The system of claim 9, wherein the composition zone is an advertisement area.

14. The system of claim 13, wherein the composition zone definition further comprises a purchase cost.

15. The system of claim 13, wherein the composition zone definition further comprises a target group of advertisers.

16. The system of claim 1, wherein the layout definition further defines a layout space, and wherein the layout space is at least in part controlled by the composition zone definition.

17. The system of claim 16, wherein the layout definition includes a size of the layout space.

18. The system of claim 16, wherein the layout space is further controlled, at least in part, by the job definition.

19. The system of claim 1, wherein the composition zone definition defines a composition zone, wherein the layout definition is a first layout definition defining a first layout associated with a first portion of the composition zone, and wherein the instruction set further includes instructions executable by the microprocessor based controller to:
receive a second layout definition, wherein the second layout definition defines a second layout including at least one content object from the content object set, and wherein the second layout is associated with a second portion of the composition zone.

20. The system of claim 1, wherein the composition definition defines a first composition zone and a second composition zone, wherein the layout definition is a first layout definition and the layout is a first layout associated with the first composition zone, and wherein the instruction set further includes instructions executable by the microprocessor based controller to:
receive a second layout definition, wherein the second layout definition defines a second layout including at least one content object from the content object set, and wherein the second layout is associated with a first portion of the second composition zone; and
receive a third layout definition, wherein the third layout definition defines a third layout including at least one content object from the content object set, and wherein the third layout is associated with a second portion of the second composition zone.

21. The system of claim 1, wherein the first media is a print media, and wherein the second media is an electronic media.

22. The system of claim 21, wherein the print media is selected from a group consisting of: a magazine, a newspaper, a product package, a paper advertisement, a business card, and a painted billboard.

23. The system of claim 21, wherein the electronic media is selected from a group consisting of: a non-interactive Internet page, an interactive Internet page, an electronic billboard, a video program, and an audio program.

24. The system of claim 1, wherein the first media is a product media, and wherein the product media is selected from a group consisting of: a wearable product, a compact disk, a semiconductor device, and a pharmaceutical product.

25. The system of claim 1, wherein the content object from the content object set includes a first form and a second form, and wherein the first form is selected for export in relation to the first media and the second form is selected for export in relation to the second media.

26. The system of claim 1, wherein the layout is tailored for the first media, and wherein exporting the product to the first media and the second media includes applying styling rules to the product in the first media to create the product in the second media.

27. The system of claim 1, wherein the content object in the product for the first media is synchronized to the corresponding content object in the product for the second media.

28. The system of claim 27, wherein the instruction set further includes instructions executable by the microprocessor based controller to:
receive a change to the content object, and to reflect the change-to the content object in both the product for the first media and the product for the second media.

29. The system of claim 1, wherein the composition zone definition defines a composition zone, and wherein the composition zone in the product for the first media is synchronized to the composition zone in the product for the second media.

30. The system of claim 29, wherein the instruction set further includes instructions executable by the microprocessor based controller to:
receive a change to the composition zone definition, and to reflect the change to the composition zone in both the product for the first media and the product for the second media.

31. The system of claim 1, wherein the content object is selected from a group consisting of: a static content object and a variable content object.
